(19) United States
(12) Patent Application Publication
(10) Pub. No.: US 2024/0193617 A1
(43) Pub. Date: Jun. 13, 2024

(54) METHODS AND APPARATUS TO ASSIGN WORKLOADS BASED ON EMISSIONS ESTIMATES

(71) Applicant: Intel Corporation, Santa Clara, CA (US)

(72) Inventors: Francesc Guim Bernat, Barcelona (ES); Karthik Kumar, Chandler, AZ (US); Akhilesh S. Thyagaturu, Tampa, FL (US); Thijs Metsch, Bruehl (DE); Adrian Hoban, Cratloe (IE)

(21) Appl. No.: 18/542,370

(22) Filed: Dec. 15, 2023

(51) Int. Cl. G06Q 30/018; G06F 9/50

(52) U.S. Cl. CPC G06Q 30/018; G06F 9/505

(57) ABSTRACT

Systems, apparatus, articles of manufacture, and methods are disclosed. An example apparatus includes programmable circuitry to at least: obtain a first response associated with an estimate of emissions to be produced by execution of a workload on first hardware; obtain a second response associated with an estimate of emissions to be produced by execution of the workload on second hardware; and assign one of the first or the second hardware to execute the workload based on the first response and the second response, the assigned one of the first or the second hardware to at least one of utilize more time or more memory to execute the workload than the other of the first or the second hardware.

### FIELD OF THE DISCLOSURE

This disclosure relates generally to computing, and, more particularly, to methods and/or apparatus to assign workloads based on emission estimates.

### BACKGROUND

Sustainable computing is a growing and/or increasingly relevant practice to address global climate concerns. Sustainable computing refers to one or more of: designing, manufacturing, using, recycling, and/or disposing of compute devices in a manner that utilizes environmentally friendly materials, reduces energy consumption, and/or reduces the emission of greenhouse gasses (GHGs).

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and/or cloud computing environments.

FIG. 3 illustrates an example approach for networking and/or services in an Edge computing system.

FIG. 4A is a block diagram illustrating a first example system to select a compute resource based on estimated energy costs in an example environment of use.

FIG. 4B is a block diagram illustrating a second example system to select a compute resource based on estimated energy costs in an example environment of use.

FIG. 5 is a block diagram of an example implementation of the emission estimator circuitry of FIGS. 4A and/or 4B.

FIG. 6 is a block diagram of an example implementation of an example edge device of FIGS. 4A and/or 4B.

FIG. 7 illustrates example variables that influence the GHG emissions contributable to a compute component.

FIG. 8 illustrates example component profiles which influence the GHG emissions contributable to a compute component.

FIG. 9 is a flowchart representative of example machine-readable instructions and/or example operations that may be executed, instantiated, and/or performed by example programmable circuitry to implement the emission estimator circuitry of FIGS. 4A and/or 4B.

FIG. 10 is a flowchart representative of example machine-readable instructions and/or example operations that may be executed, instantiated, and/or performed by example programmable circuitry to implement block 906 of FIG. 9.

FIG. 11 is a flowchart representative of example machine-readable instructions and/or example operations that may be executed, instantiated, and/or performed by example programmable circuitry to implement block 908 of FIG. 9.

FIG. 12 is a flowchart representative of example machine-readable instructions and/or example operations that may be executed, instantiated, and/or performed by example programmable circuitry to implement the resource manager circuitry of FIG. 4B.

FIG. 13 is a block diagram of an example processing platform including programmable circuitry structured to execute, instantiate, and/or perform the example machine-readable instructions and/or perform the example operations of FIGS. 9-12 to implement the emission estimator circuitry 404 and/or GHG-aware scheduling system of FIGS. 4A and/or 4B.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and/or accompanying written description to refer to the same or like parts. The figures are not necessarily to scale.

### DETAILED DESCRIPTION

The energy consumption that corresponds to a device may come from a variety of energy sources over a wide range of time. As a result, tracking the quantity or type of greenhouse gas (GHG) contributable to a particular device is a challenging task. In some examples, GHG emissions contributable to a single compute device may be categorized as belonging to Scope 2 emissions or Scope 3 emissions.

Scope 2 emissions generally refer to indirect emissions from the generation of energy to operate a device. Within the context of sustainable computing, scope 2 emissions may occur when generating energy used by a compute device to execute a workload. Scope 2 emissions may also occur when generating energy used to cool the compute device while it executes the workload. As used herein, a workload may refer to any operations performed by a compute device. In some examples, a workload is implemented by executing machine-readable instructions for a specific task (e.g., an application) and/or for infrastructure tasks (e.g., an operating system, a virtual compute environment (e.g., a virtual machine or container), and/or other firmware and/or software).

Scope 3 emissions generally refer to indirect emissions from the usage of energy associated with the compute device or energy within the value chain of a company (e.g., business activities that occur while creating a product or service). Scope 3 emissions refer to energy used both in the upstream value chain (e.g., pre-production business activities) and/or the downstream value chain (e.g., post-production business activities). Within the context of sustainable computing, scope 3 emissions may occur when using energy to source materials that compose a compute device, and/or to use the materials in a manufacturing process that creates the compute device. Scope 3 emissions may also occur while using energy after a compute device has reached the end of its lifespan and/or is treated as waste (e.g., sent to a landfill, recycled, etc.).

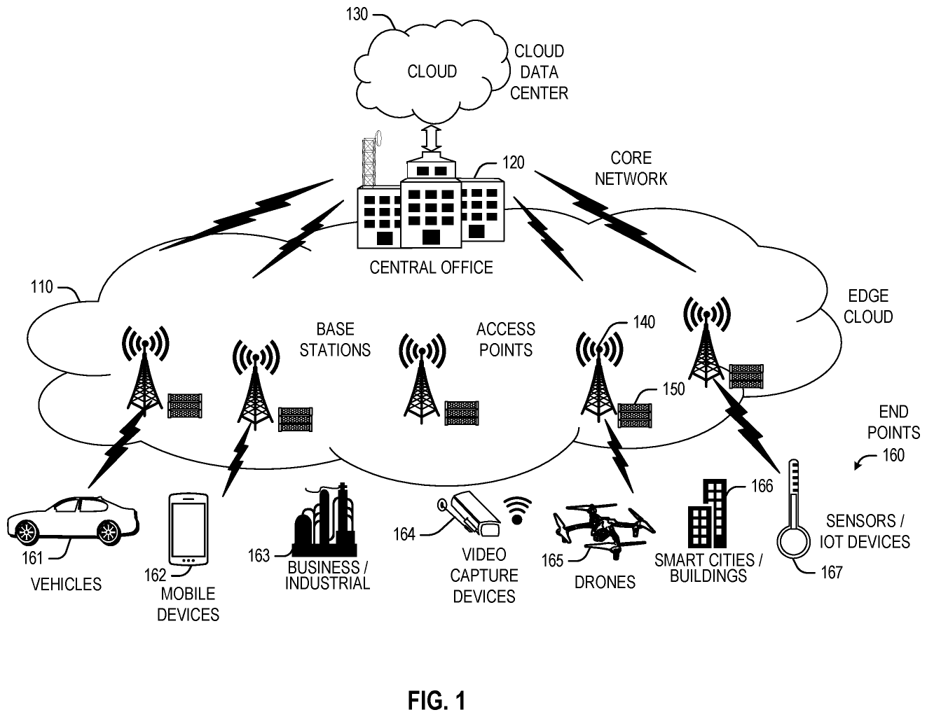

By the time a compute device is in operation, an amount of GHG emissions have already occurred through the design, manufacture, distribution, and/or sale of the compute device. However, a significant portion of the scope 2 and/or scope 3 emissions contributable to a compute device depend on how the compute device is used while in operation. For example, a client device in communication with an edge cloud may submit a workload that multiple edge devices are capable of executing. The multiple edge devices may be powered by different types of energy sources, be cooled by different types of energy sources, and/or be at different points in their respective product lifespans. Variations between devices results in a dependency between the amount of GHG emissions caused by a given workload and/or the edge device that is chosen to perform the execution. Edge clouds are discussed further in connection with FIGS. 1-3.

Example methods, apparatus, and/or systems described herein enable the assignment of a workload to an edge device based on GHG emissions that may result from the assignment. An example GHG-aware scheduling system submits a workload to the edge cloud and/or selects an edge device capable of running the workload. Within the edge cloud, example emission estimator circuitry (which may be implemented by executable instructions in combination with hardware programmed by the instructions) uses the workload to estimates GHG emissions caused by running the workload on the selected edge device, by cooling the selected edge device while it runs the workload, and/or by reducing the lifespan of the selected edge device as a result of running the proposed workload. The example emission estimator circuitry may describe the estimated emissions in a GHG report and/or return the report to the example client device. Accordingly, GHG-aware scheduling system can assign a workload to a first edge device instead of a second device because GHG reports for both devices indicate the first edge device would execute the workload in a more energy efficient manner. The GHG-aware scheduling system may choose to assign a workload based on one or more sustainability issues related to energy usage and/or environmental impacts in view of or in addition to other factors such as computational efficiency).

A GHG-aware scheduling system can use the GHG report to choose to prioritize sustainability over other load balancing factors. For example, the foregoing assignment of the workload to the first device may occur despite the second device being able to execute the workload at a higher computational efficiency than the first device. As used herein, computational efficiency is defined to include the amount of time required for a device to execute a workload (e.g., latency, a wait time, etc.), the amount of compute currently (e.g., processor clock cycles) used to execute the workload, a queue depth, and/or the amount of memory used by the device to execute the workload.

FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and/or thus may include multiple entities, devices, and/or equipment instances. The Edge cloud 110 is located much closer to the endpoint (consumer and/or producer) data sources 160 (e.g., autonomous vehicles 161, user equipment 162, business and/or industrial equipment 163, video capture devices 164, drones 165, smart cities and/or building devices 166, sensors and/or IoT devices 167, etc.) than the cloud data center 130. Compute, memory, and/or storage resources which are offered at the edges in the Edge cloud 110 are critical to providing ultra-low latency response times for services and/or functions used by the endpoint data sources 160 as well as reduce network backhaul traffic from the Edge cloud 110 toward cloud data center 130 thus improving energy consumption and/or overall network usages among other benefits.

Compute, memory, and/or storage are scarce resources, and/or generally decrease depending on the Edge location (e.g., fewer processing resources being available at consumer endpoint devices, than at a base station, than at a central office). However, the closer that the Edge location is to the endpoint (e.g., user equipment (UE)), the more that space and/or power is often constrained. Thus, Edge computing attempts to reduce the amount of resources needed for network services, through the distribution of more resources which are located closer both geographically and/or in network access time. In this manner, Edge computing attempts to bring the compute resources to the workload data where appropriate or bring the workload data to the compute resources.

The following describes aspects of an Edge cloud architecture that covers multiple potential deployments and/or addresses restrictions that some network operators or service providers may have in their own infrastructures. These include, variation of configurations based on the Edge location (because edges at a base station level, for instance, may have more constrained performance and/or capabilities in a multi-tenant scenario); configurations based on the type of compute, memory, storage, fabric, acceleration, or like resources available to Edge locations, tiers of locations, or groups of locations; the service, security, and/or management and/or orchestration capabilities; and/or related objectives to achieve usability and/or performance of end services. These deployments may accomplish processing in network layers that may be considered as “near Edge”, “close Edge”, “local Edge”, “middle Edge”, or “far Edge” layers, depending on latency, distance, and/or timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and/or consuming the data. For example, Edge gateway servers may be equipped with pools of memory and/or storage resources to perform computation in real-time for low latency use-cases (e.g., autonomous driving or video surveillance) for connected client devices. Or as an example, base stations may be augmented with compute and/or acceleration resources to directly process service workloads for connected user equipment, without further communicating data via backhaul networks. Or as another example, central office network management hardware may be replaced with standardized compute hardware that performs virtualized network functions and/or offers compute resources for the execution of services and/or consumer functions for connected devices.

Within Edge computing networks, there may be scenarios in services where the compute resource will be “moved” to the data, as well as scenarios in which the data will be “moved” to the compute resource. Or as an example, base station compute, acceleration and/or network resources can provide services in order to scale to workload demands on an as needed basis by activating dormant capacity (subscription, capacity on demand) in order to manage corner cases, emergencies or to provide longevity for deployed resources over a significantly longer implemented lifecycle. The “movement” of a compute resource or data throughout an Edge computing network may require one or more devices in the network transmission path to perform operations (e.g., receive a packet, interpret the packet, forward the packet, etc.). Because performing operations requires energy consumption, some amount of GHG emissions may be caused by each device in the network transmission path. Accordingly, the size of the network transmission path, telemetry data relating to devices in the network transmission path, etc., may contribute to scope 2 and/or scope 3 emissions formed by submitting a workload to an Edge computing network for execution.

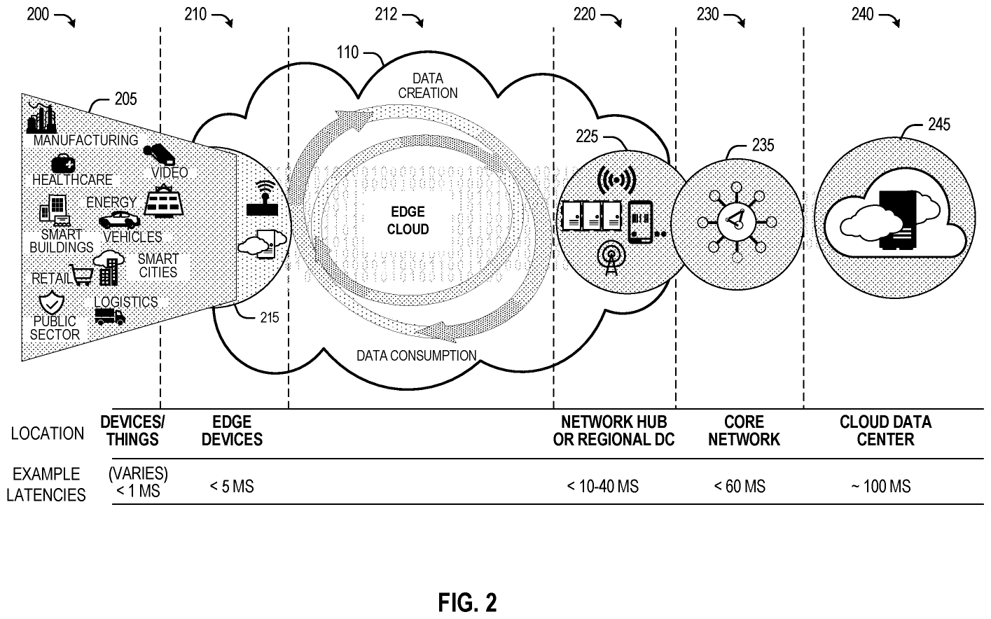

FIG. 2 illustrates operational layers among endpoints, an Edge cloud, and/or cloud computing environments. Specifically, FIG. 2 depicts examples of computational use cases 205, utilizing the Edge cloud 210 among multiple illustrative layers of network computing. The layers begin at an endpoint (devices and/or things) layer 200, which accesses the Edge cloud 110 to conduct data creation, analysis, and/or data consumption activities. The Edge cloud 110 may span multiple network layers, such as an Edge devices layer 110 having gateways, on-premise servers, or network equipment (nodes 215) located in physically proximate Edge systems; a network access layer 220, encompassing base stations, radio processing units, network hubs, regional data centers (DC), or local network equipment (equipment 225); and/or any equipment, devices, or nodes located therebetween (in layer 212, not illustrated in detail). The network communications within the Edge cloud 110 and/or among the various layers may occur via any number of wired or wireless mediums, including via connectivity architectures and/or technologies not depicted.

Examples of latency, resulting from network communication distance and/or processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and/or cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and/or contrast; it will be understood that the use of other access network mediums and/or technologies may further reduce the latencies. In some examples, respective portions of the network may be categorized as “close Edge”, “local Edge”, “near Edge”, “middle Edge”, or “far Edge” layers, relative to a network source and/or destination. For instance, from the perspective of the core network data center 235 or a cloud data center 245, a central office or content data network may be considered as being located within a “near Edge” layer (“near” to the cloud, having high latency values when communicating with the devices and/or endpoints of the use cases 205), whereas an access point, base station, on-premise server, or network gateway may be considered as located within a “far Edge” layer (“far” from the cloud, having low latency values when communicating with the devices and/or endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and/or Quality of Service (QOS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and/or Resiliency (e.g., some input streams need to be acted upon and/or the traffic routed with mission-critical reliability, where as some other input streams may be tolerate an occasional failure, depending on the application); (c) Physical constraints (e.g., power, cooling and/or form-factor, etc.); and/or (d) Data Security (e.g., some governments, regulatory bodies, and/or organizations impose data restrictions due to privacy concerns).

The end-to-end service view for these use cases involves the concept of a service-flow and/or is associated with a transaction. The transaction details the overall service requirement for the entity consuming the service, as well as the associated services for the resources, workloads, workflows, and/or business functional and/or business level requirements. The services executed with the “terms” described may be managed at each layer in a way to assure real time, and/or runtime contractual compliance for the transaction during the lifecycle of the service. When a component in the transaction is missing its agreed to Service Level Objective (SLO) and/or Service Level Agreement (SLA), the system as a whole (components in the transaction) may provide the ability to (1) understand/or the impact of the SLO/SLA violation, and/or (2) augment other components in the system to resume overall transaction SLO/SLA, and/or (3) implement actions to remediate

Thus, with these variations and/or service features in mind, Edge computing within the Edge cloud 110 may provide the ability to serve and/or respond to multiple applications of the use cases 205 (e.g., object tracking, video surveillance, connected cars, etc.) in real-time or near real-time, and/or meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and/or therefore there is pressure on usage of Edge resources. Typically, this is addressed through the pooling of memory and/or storage resources for use by multiple users (tenants) and/or devices. The Edge may be power and/or cooling constrained and/or therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and/or root of trust trusted functions are also required, because Edge locations may be unmanned and/or may even need permissioned access (e.g., when housed in a third-party location). Such issues are magnified in the Edge cloud 110 in a multi-tenant, multi-owner, or multi-access setting, where services and/or applications are requested by many users, especially as network usage dynamically fluctuates and/or the composition of the multiple stakeholders, use cases, and/or services changes.

At a more generic level, an Edge computing system may be described to encompass any number of deployments at the previously discussed layers operating in the Edge cloud 110 (network layers 200-240), which provide coordination from client and/or distributed computing devices. One or more Edge gateway nodes, one or more Edge aggregation nodes, and/or one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and/or configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and/or functional features operated by and/or within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and/or traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and/or forms of network access (e.g., Wi-Fi, long-range wireless, wired networks including optical networks, etc.) may also be utilized in place of or in combination with such 3GPP carrier networks.

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input device such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and/or may be provided with a housing having a form factor suitable for its primary purpose; yet be available for other compute tasks that do not interfere with its primary task. Edge devices include Internet of Things devices. The appliance computing device may include hardware and/or software components to manage local issues such as device temperature, vibration, resource utilization, updates, power issues, physical and/or network security, etc. The Edge cloud 110 may also include one or more servers and/or one or more multi-tenant servers. Such a server may include an operating system and/or implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

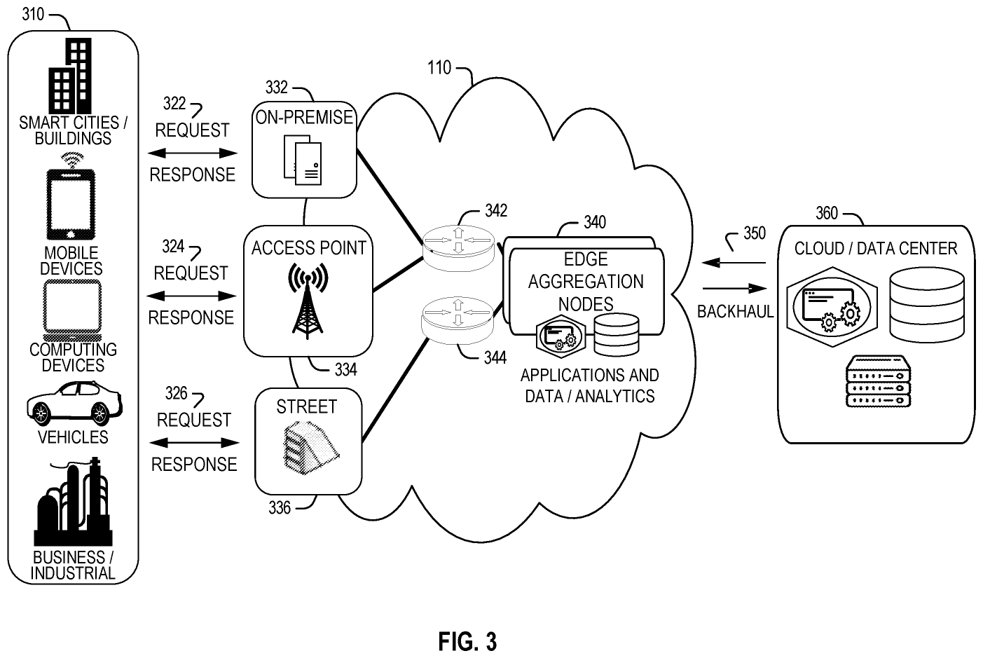

In FIG. 3, various client endpoints 310 (in the form of mobile devices, computers, autonomous vehicles, business computing equipment, industrial processing equipment) exchange requests and/or responses that are specific to the type of endpoint network aggregation. For instance, client endpoints 310 may obtain network access via a wired broadband/or network, by exchanging requests and/or responses 322 through an on-premise network system 332. Some client endpoints 310, such as mobile computing devices, may obtain network access via a wireless broadband/or network, by exchanging requests and/or responses 324 through an access point (e.g., a cellular network tower) 334. Some client endpoints 310, such as autonomous vehicles may obtain network access for requests and/or responses 326 via a wireless vehicular network through a street-located network system 336. However, regardless of the type of network access, the TSP may deploy aggregation points 342, 344 within the Edge cloud 110 to aggregate traffic and/or requests. Thus, within the Edge cloud 110, the TSP may deploy various compute and/or storage resources, such as at Edge aggregation nodes 340, to provide requested content. The Edge aggregation nodes 340 and/or other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and/or the aggregation points 342, 344, including those deployed on a single server framework, may also be present within the Edge cloud 110 or other areas of the TSP infrastructure.

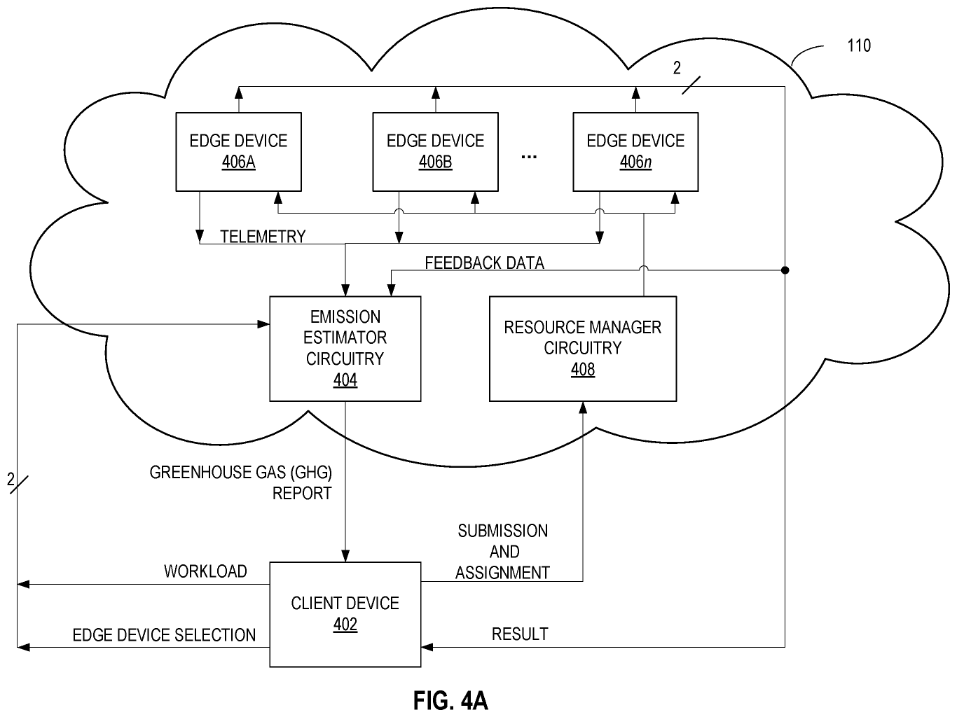

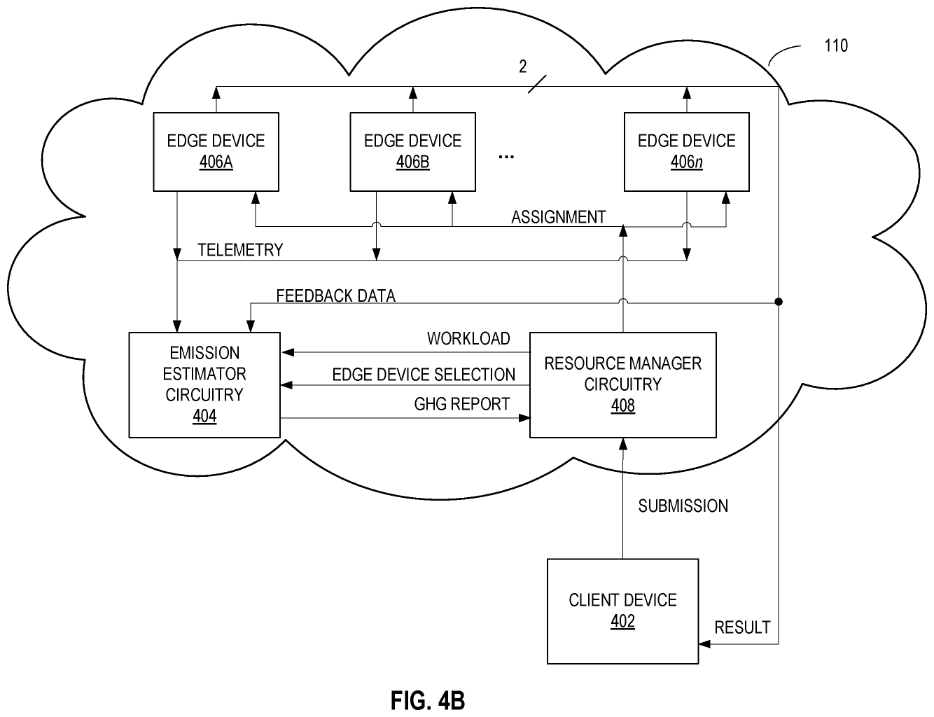

FIG. 4A is a block diagram illustrating an example system to select a compute resource based on GHG reports in an example environment of use. The compute system pf FIG. 4A includes an example client device 402 and/or the example edge cloud 110 of FIG. 1. In the example of FIG. 4A, the edge cloud 110 includes example emission estimator circuitry 404, example edge devices 406A, 406B, . . . , 406n (collectively referred to as edge devices 406), and/or example resource manager circuitry 408.

The example client device 402 of FIG. 1 is a device that submits a workload to the edge cloud 110 for remote execution. In the example of FIG. 4A, the client device 402 also assigns the workload to one of the edge devices 406 within the edge cloud 110. While examples described herein may refer to the edge device 406A as the assigned edge device, the client device 402 may assign workloads to any of the edge devices 406. Moreover, the assignment of an edge device to process a workload may be done by a device other than the client device 402 (e.g., by the resource manager circuitry 408 as shown in FIG. 4B, by one of the edge devices 406, by a different device within or connected the edge cloud 110, etc.). In some examples, assigning a workload to a device for remote execution may be referred to as scheduling.

Before assigning the workload to one of the edge devices 406, the example client device 402 (or another device responsible for the assignment workload) obtains one more GHG reports of the edge devices 406. The client device 402 then uses the one or more GHG factors from one or more GHG reports as a basis for assigning the workload. For example, the client device 402 may receive one GHG report corresponding to one edge device and/or assign the workload to the edge device if one or more parameters within the GHG report are below certain thresholds. Additionally or alternatively, the example client device 402 may receive two GHG reports corresponding to two edge devices and/or assign the workload to the edge device whose GHG report indicates a lower amount of total GHG emissions. In some examples, the client device 402 (or another device responsible for the assignment workload) uses other factors, in addition to GHG factors, when assigning the workload.

The client device 402 of this example may be implemented by any of the example data sources 160 of FIG. 1, the example use cases 205 of FIG. 2, and/or the example client endpoints 310 of FIG. 3. In some examples, the client device 402 may refer to a compute node, a workstation, a wireless device, an endpoint, a network switch, etc. The client device 402 may be additionally or alternatively referred to as a consumer device, an edge device, a fog device, and/or a cloud device. The example of FIG. 1 shows one client device 402 for simplicity. In practice, any number of client devices may assign workloads based on GHG factors.

The example client device 402 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and/or integrated circuits such as Application Specific Integrated Circuits (ASICs).

Within the edge cloud 110 of this example, the example emission estimator circuitry 404 receives the workload and/or an edge device selection from the client device 402. The example emission estimator circuitry 404 then produces a GHG report. The GHG report may estimate the GHG emissions that could be caused by the selected edge device running the workload. In some examples, the GHG report may be referred to as an estimation of carbon emissions, carbon dioxide equivalents, etc. In some examples, the GHG report may estimate a subset of the emissions generally referred to as greenhouse gases (e.g., one or more of carbon dioxide, methane, nitrous oxide, various synthetic chemicals, water vapor, etc.). Thus, as used herein GHG is understood to refer to one or more emissions of one or more types.

In the example of FIG. 4A, the emission estimator circuitry 404 may use Application Programming Interface (API) calls to communicate with the client device 402. Such communications may include the exchange of the workload, the edge device selection, and/or the corresponding GHG report. As used herein, an API is defined to be an interface that provides a standard and/or protocol format for exchanging data between two computer components. In some examples, an API call is a specific message sent by a first component in a format recognizable by a second component. Examples of API calls used by the emission estimator circuitry 404 may include, but are not limited to, query API calls, enable API calls, disable API calls, etc. In some examples, an API call in which a device requests data is referred to as an API request, and/or an API message that provides said data is referred to as an API response.

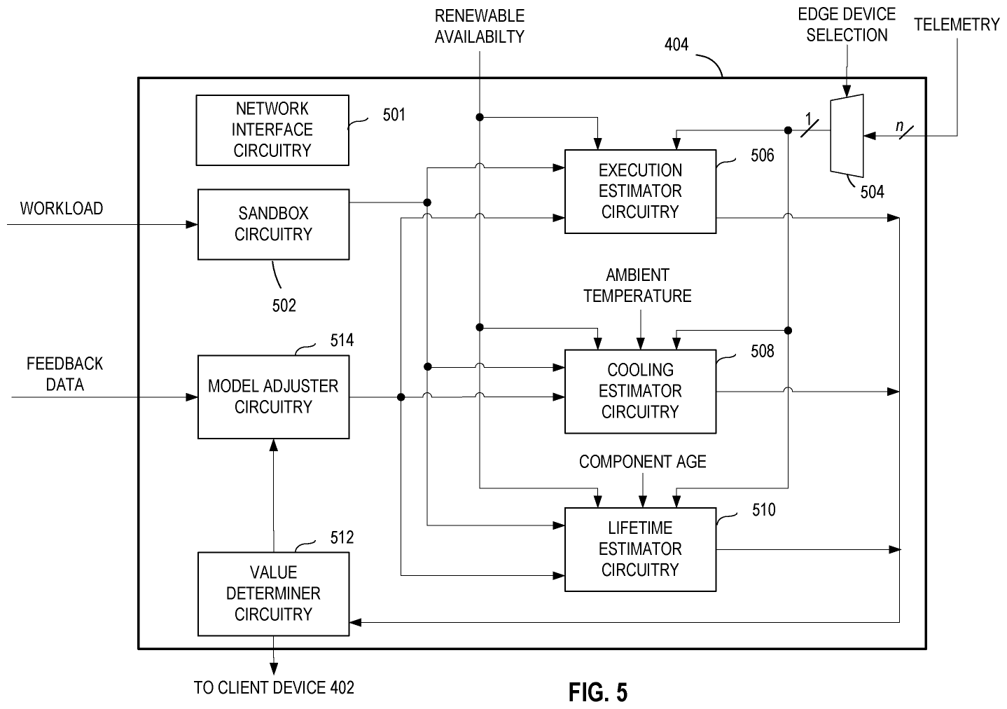

To produce the GHG report, the example emission estimator circuitry 404 of the illustrated example performs operations using telemetry data obtained from the edge device 406A selected by the client device 402. Accordingly, the emission estimator circuitry 404 may connect to and/or obtain telemetry data from any of the edge devices 406. The example emission estimator circuitry 404 also returns the GHG report to the client device 402. The example emission estimator circuitry 404 may be implemented by any type of programmable circuitry. An example implementation of the emission estimator circuitry 404 is discussed further in connection with FIG. 5.

The example resource manager circuitry 408 manages the resources available in the edge cloud 110 for remote execution (e.g., the edge devices 406). In the example of FIG. 4A, the client device 402 uses one or more GHG reports generated by the emission estimator circuitry 404 to determine which of the edge devices 406 to assign the workload to. In such an example, the resource manager circuitry 408 receives the assignment (e.g., edge device 406) and/or the workload itself from the client device 402. The resource manager circuitry 408 then forwards the workload to the assigned edge device 406A.

In the example of FIG. 4A, the example edge devices 406 execute workloads that are submitted by client devices, assigned by the client devices, and/or forwarded by the resource manager circuitry 408. The execution of the workload produces a result, which the assigned edge device 406A shares with the client device 402. In the example of FIG. 4A, the edge devices 406 transmit results directly to the client device 402. In other examples, the edge devices 406 provide results to the client device 402 via one or more intermediary devices (e.g., the resources manager circuitry 408).

The example assigned edge device 406A also provides the emission estimator circuitry 404 with feedback data corresponding to the result. The feedback data may quantify the computational efficiency at which the result was produced (e.g., the computational efficiency at which the workload was executed). The feedback data may additionally or alternatively provide metrics that quantify the amount of energy and/or amount of GHG emissions consumed while producing the result/executing the workload. To provide feedback data to the emission estimator circuitry 404, the assigned edge device 406A may transmit telemetry metrics in real time (or pseudo real time) during the execution of the workload. Examples of telemetry data that may be included in the feedback data include, but are not limited to, an amount of time used to execute the workload, an amount of storage used while executing the workload, a number of processor cycles used to execute the workload, a percentage of processor cycles used to execute the workload, one or more temperature readings from the edge device 406A, an amount of power consumed (e.g., by the programmable circuitry, by a cooling apparatus, and/or other hardware of the executing device) while executing the workload, etc. The example emission estimator circuitry 404 may use the feedback data to adjust estimation techniques that produce the GHG report (if necessary to improve accuracy).

The example edge devices 406 may be implemented by any type of programmable circuitry. The edge devices 406 may be implemented by any amount of compute resources and/or may be implemented in any location. In some examples, one or more of the edge devices 406 are located together in a data center.

FIG. 4B is a block diagram illustrating a second example technique to select a compute resource based on estimated energy costs in an example environment of use. FIG. 4B includes the same components as FIG. 4A. However, in the example of FIG. 4B, the client device 402 submits the workload to the resource manager circuitry 408 which then assigns the workload to one of the edge devices 406 based on GHG factors. The example of FIG. 4B contrasts with the example of FIG. 4A in which the client device 402 both submits the workload to the edge cloud 110 and/or assigns the workload to one of the edge devices 406.

A GHG-aware scheduling system (e.g., the client device 402 in FIG. 4A, the resource manager circuitry 408 in FIG. 4B, etc.) may assign a workload using any suitable technique. In some examples, the GHG-aware scheduling system may use Single Root I/O Virtualization (SR-IOV) to assign workloads to containers and/or virtual machines within one or more edge devices 406. Generally, SR-IOV is an extension of the Peripheral Component Interconnect Express (PCIe) protocol that enables devices to share hardware resources with one another. In some examples, the GHG-aware scheduling system additionally or alternatively uses the Intel® Scalable IOV to assign workloads to containers and/or virtual machines within one or more edge devices 406.

To obtain GHG reports in FIG. 4B, the resource manager circuitry 408 sends a workload description and/or an edge device selection to the emission estimator circuitry 404. The example emission estimator circuitry 404 and/or the example resource manager circuitry 408 communicate with one another using API requests and/or API responses as discussed above in connection with FIG. 4A. The resource manager circuitry 408 then assigns the workload to one of the edge devices 406 based at least in part on the GHG reports.

The example resource manager circuitry 408 may use other factors in addition to GHG factors from GHG reports when determining where to assign a workload. Such other factors may include, but are not limited to, a request from the client device 402 to execute the workload on a particular edge device 406A, performance requirements corresponding to the workload, the current utilization of the edge devices, a Quality of Service (QOS) agreement, a Service Level Agreement (SLA), etc. In some examples, the resource manager circuitry 408 of FIG. 4B is referred to as edge orchestrator circuitry and/or edge gateway circuitry.

Similarly, the resource manager circuitry 408 may function as an orchestrator within an Operations Support System (OSS) or a Business Support System (BSS) when using use GHG factors to assign workloads as. In such examples, the resource manager circuitry 408 may use the GHG reports to bill and/or meter the client device 402 for remote execution on the edge cloud 110.

In the example of FIG. 4B, the client device 402, the edge devices 406, and/or the resource manager circuitry 408 use GHG reports while implementing a cloud computing architecture referred to as Infrastructure as a Service (IaaS). IaaS generally refers to cloud computing services that offer computing, storage and/or networking resources on-demand/or (e.g., clients pay for usage of the resources as the need arises). In other examples, GHG reports may be used to implement a different cloud computing architecture. Examples of other cloud computing architectures include, but are not limited to, cloud another Platform as a Service (PaaS), Software as a Service (SaaS), Function as a Service (FaaS), etc.

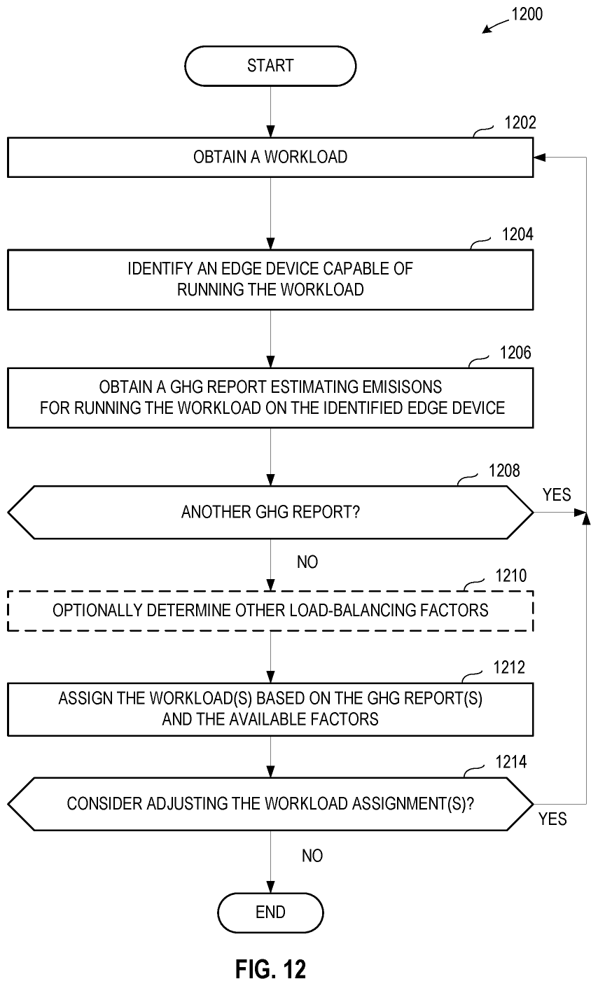

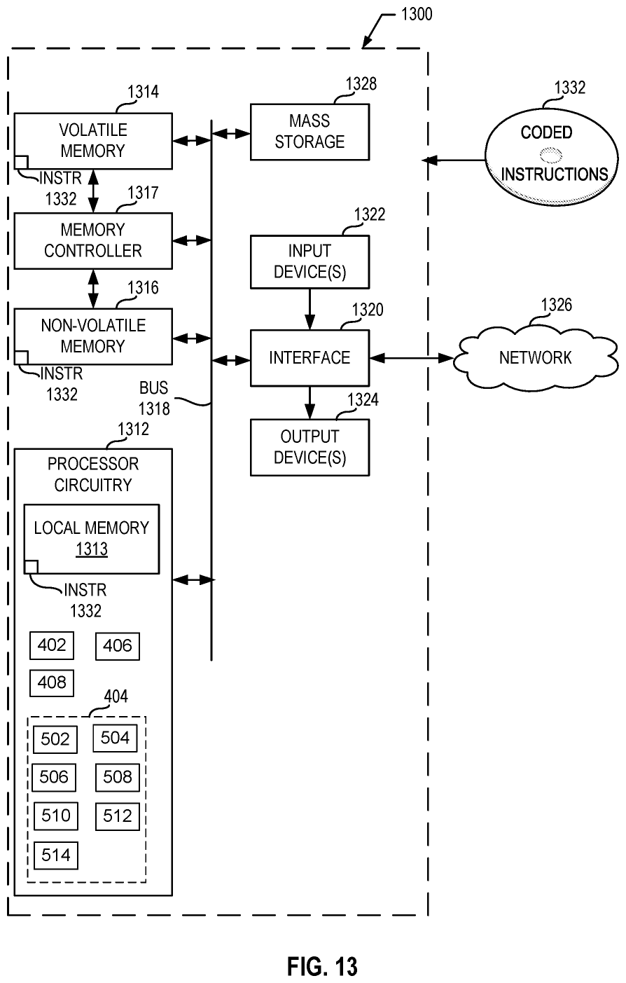

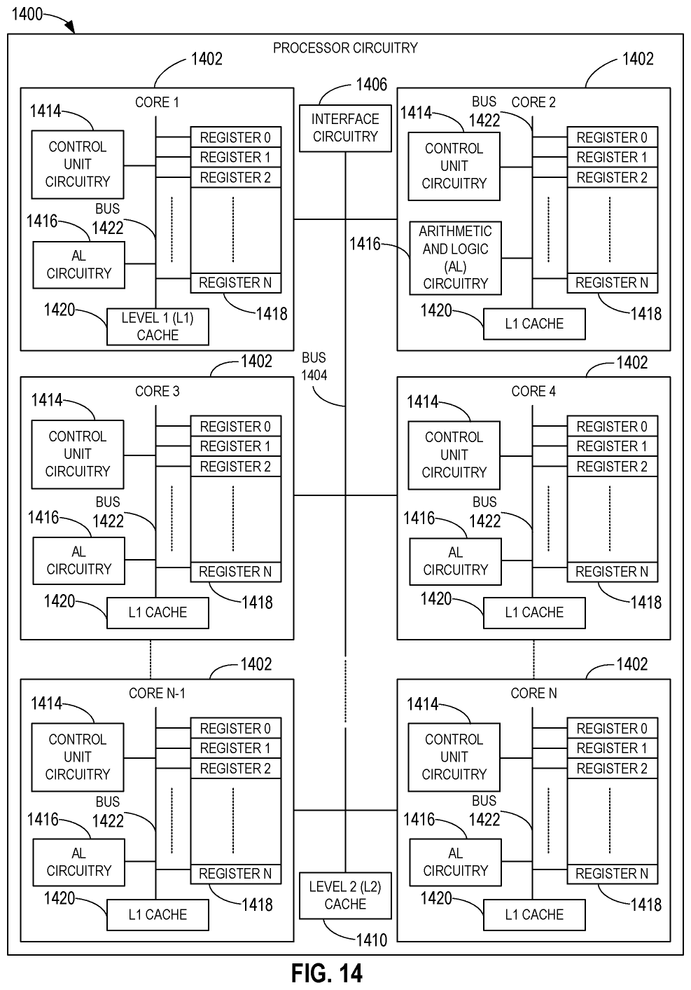

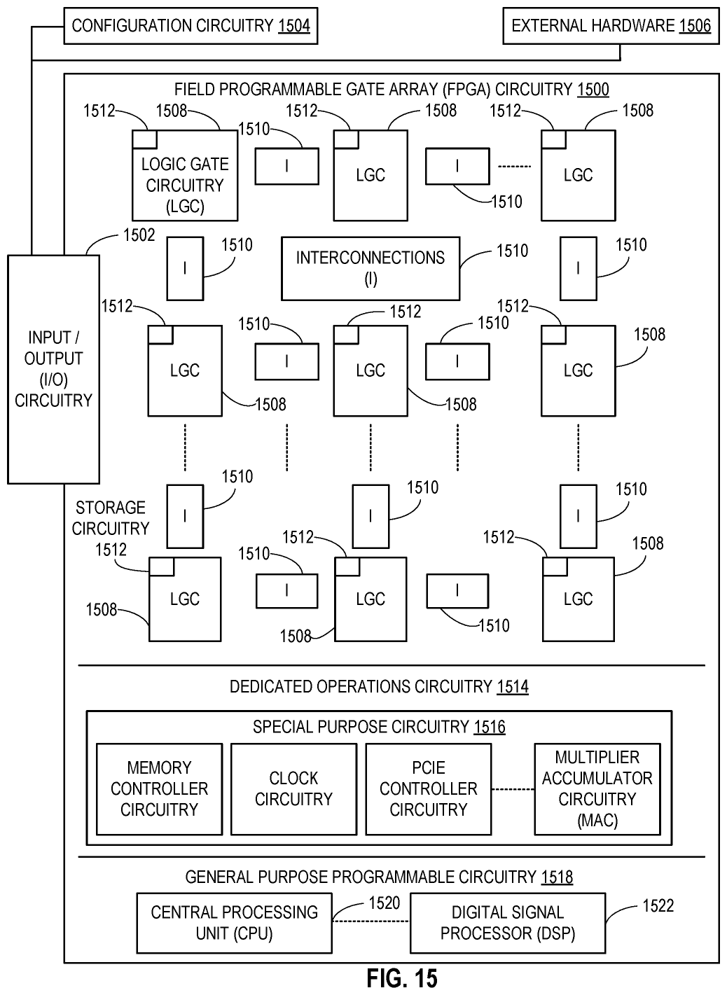

In some examples, the environments of FIGS. 4A and/or 4B include means for assigning a workload. For example, the means for determining may be implemented by client device 402 or resource manager circuitry 408. In some examples, the client device 402 or resource manager circuitry 408 may be instantiated by programmable circuitry such as the example programmable circuitry 1312 of FIG. 13. For instance, the client device 402 or resource manager circuitry 408 may be instantiated by the example microprocessor 1400 of FIG. 14 executing machine executable instructions such as those implemented by at least blocks 1202-1214 of FIG. 12. In some examples, the client device 402 or resource manager circuitry 408 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the client device 402 or resource manager circuitry 408 may be instantiated by any other combination of hardware, software, and/or firmware. For example, the client device 402 or resource manager circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 5 is a block diagram of an example implementation of the emission estimator circuitry of FIG. 4. The emission estimator circuitry 404 and/or GHG-aware scheduling system of FIG. 5 may be instantiated (e.g., creating an instance of, bring into being for any length of time, materialize, implement, etc.) by programmable circuitry such as a Central Processor Unit (CPU) executing first instructions. Additionally or alternatively, the emission estimator circuitry 404 and/or GHG-aware scheduling system of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers. The example emission estimator circuitry 404 includes example network interface circuitry 501, example sandbox circuitry 502, an example multiplexer 504, example execution estimator circuitry 506, example cooling estimator circuitry 508, example lifetime estimator circuitry 510, example value determiner circuitry 512, and/or example model adjuster circuitry 514.

The example network interface circuitry 501 enables exchange of data between various devices connected to the edge cloud 110 and/or the internal components of the emissions estimator circuitry 404. For example, the network interface circuitry 501 may obtain, via, for example, the edge cloud 110, the workload and/or edge selection from the client device 402 or resource manager circuitry 408, renewable availability data from a GHG-density service, telemetry data from the edge devices 406, etc. The example network interface circuitry 501 may also transmit a GHG report to the client device 402 and/or resource manager circuitry 408 via the edge cloud 110. The example network interface circuitry 501 may include transceivers, antennas, and/or other hardware components required to send and/or receive data over the edge cloud 110. Similarly, the example network interface circuitry 501 may implement any number of wired and/or wireless communication protocols to exchange data over the edge cloud 110.

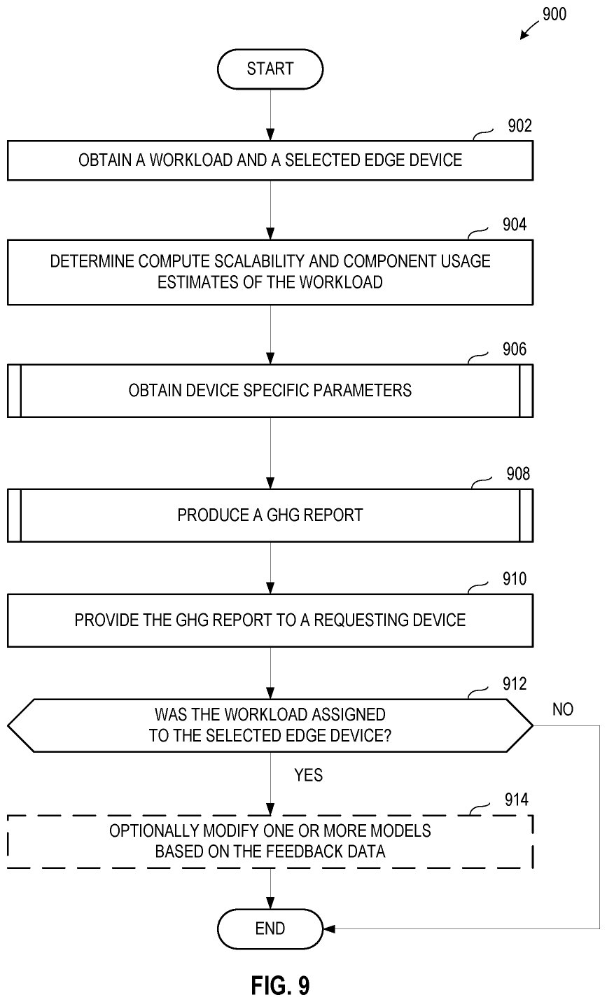

In some examples, the emissions estimator circuitry 404 includes means for obtaining data. For example, the means for obtaining may be implemented by network interface circuitry 501. In some examples, the network interface circuitry 501 may be instantiated by programmable circuitry such as the example programmable circuitry 1312 of FIG. 13. For instance, the network interface circuitry 501 may be instantiated by the example microprocessor 1400 of FIG. 14 executing machine executable instructions such as those implemented by at least blocks 902, 1002, 1004, 1006, 1008 of FIGS. 9 and/or 10. In some examples, the network interface circuitry 501 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the network interface circuitry 501 may be instantiated by any other combination of hardware, software, and/or firmware. For example, the network interface circuitry 501 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example sandbox circuitry 502 obtains the workload, via the network interface circuitry 501, from a device (e.g., the client device 402 in FIG. 4A or the resource manager circuitry 408 in FIG. 4B). The example sandbox circuitry 502 then runs the workload in a sandbox environment to determine various workload metrics. As used herein, the sandbox environment refers to an isolated virtual machine or container in which potentially unsafe software code can execute without affecting network resources or local applications. Workload metrics generated by the example sandbox circuitry 502 may be categorized as compute scalability metrics or per component usage metrics. Examples of workload metrics are discussed further below.

The sandbox circuitry 502 provides one or more of the workload metrics to the example execution estimator circuitry 506, the example cooling estimator circuitry 508, and/or the example lifetime estimator circuitry 510. In some examples, the emission estimator circuitry 404 is instantiated by programmable circuitry executing emission estimator instructions and/or configured to perform operations such as those represented by the flowchart(s) of FIGS. 9-12.

In some examples, the emissions estimator circuitry 404 includes means for determining workload metrics (e.g., compute scalability and/or component usage estimates). For example, the means for determining workload metrics may be implemented by sandbox circuitry 502. In some examples, the sandbox circuitry 502 may be instantiated by programmable circuitry such as the example programmable circuitry 1312 of FIG. 13. For instance, the sandbox circuitry 502 may be instantiated by the example microprocessor 1400 of FIG. 14 executing machine executable instructions such as those implemented by at least blocks 904 of FIG. 9. In some examples, the sandbox circuitry 502 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the sandbox circuitry 502 may be instantiated by any other combination of hardware, software, and/or firmware. For example, the sandbox circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In examples described herein, the emissions estimator circuitry receives the workload itself and/or the sandbox circuitry 502 implements the sandbox environment to obtain the foregoing workload metrics. In other examples, the client device 402 or the resource manager circuitry 408 implements the sandbox environment and/or provides the emissions estimator circuitry 404 with the configuration metrics.

In the example of FIG. 5, the multiplexer 504 receives telemetry metrics from one or more of the edge devices 406. The multiplexer 504 then provides the telemetry metrics of the selected edge device 406A to the example execution estimator circuitry 506, example cooling estimator circuitry 508, example lifetime estimator circuitry 510. In some examples, the emission estimator circuitry 404 requests telemetry data directly from the selected edge device 406A. Examples of telemetry received by the multiplexer 504 includes but is not limited to: the number of, the ambient temperature in the environment of an edge device, etc.

The example emissions estimator circuitry 404 and/or the example cooling estimator circuitry 508 both generate emissions estimates based on the availability of renewable energy to the selected edge device 406A. In some examples, renewable availability data is provided to the emission estimator circuitry 404 via a GHG-density service. As used above and/or herein, a GHG-density service refers to a data source that publishes time-series data on the GHG footprint of the energy being received by the selected edge device 406A. The GHG footprint data provided to the emission estimator circuitry 404 is based on a macro-analysis of GHG sources (e.g., the energy utility provider that powers the selected edge device 406A). The GHG footprint data may additionally or alternatively be based on a micro-analysis of GHG sources (e.g., the ratio of renewable energy sources to non-renewable sources accessible by the energy utility provider).

A GHG-density service may publish renewable availability data because calculating a GHG footprint requires a time-varying function based on multiple factors. For example, power that comes from non-fossil sources (e.g., renewable, nuclear, etc.) still has a nonzero GHG footprint that reflects various passthrough costs from embedded energy used to manufacture machinery (e.g., windmills, nuclear power plants, etc.) Meanwhile, power that comes from a grid generally contains a dynamically varying mix of fossil, nuclear, and/or solar sources. Accordingly, power that comes from a grid generally has a higher footprint reflecting both the direct GHG emissions of fossil fuels and/or estimated embedded emissions of other sources. The exact magnitude of the GHG footprint is dependent on the particular ratio of energy sources connected to the grid when a device draws power.

Furthermore, the selected edge device 406A may be entirely or partially powered by stored energy (e.g., batteries) or generated on-site from sources like fuel-cells. In such examples, the GHG footprint varies according to the carbon fraction of different energy sources (e.g., green hydrogen fuel, blue hydrogen fuel, brown hydrogen fuel, fossil fuels, etc.). The GHG footprint of batteries also includes the transitive GHG emissions from electricity that was used to charge the batteries. The GHG density service also considers how the use of an Uninterruptible Power Supply (UPS) and/or changes to the Heating, Ventilation, Airing, and/or Cooling (HVAC) within an environment of the selected edge device 406A effects the GHG footprint.

The example execution estimator circuitry 506 and/or the example cooling estimator circuitry 508 implement models that map GHG footprint data of the selected edge device 406A to GHG emissions caused by workload-specific computations on the selected edge device 406A according to the performance data provided by the sandbox circuitry 502. The GHG emissions vary according to both the performance telemetry available locally in the selected edge device 406A and/or an estimate of wasteful computations (due, for example, to dropped packets, overheads of staging computations, and/or other costs not directly measurable from the selected edge device 460A but estimated from other management operations).

The example execution estimator circuitry 506 estimates an amount of GHG emissions that may occur if the selected edge device 406A were to execute the workload. The execution estimator circuitry 506 determines the emissions estimate based on the compute scalability parameters in the workload data received from the sandbox circuitry 502. Examples of compute scalability parameters include but are not limited to core scalability factor, GPU scalability factor, frequency scalability factor, etc. The execution estimator circuitry 506 also uses renewable availability data as discussed above telemetry data specific to the selected edge device 406A (e.g., the number of processor cores of the selected edge device, the processor frequency of the selected edge device, etc.) when determining the emissions estimate.

The example execution estimator circuitry 506 determines a relationship between the foregoing parameters and/or maps the relationship to an output value (e.g., an emissions estimate) using a machine learning model. The example execution estimator circuitry 506 may implement any type of machine learning model to produce an emissions estimate, including but not limited to neural networks, decision trees, random forest algorithms, k-nearest neighbor algorithms, etc. In some examples, the example execution estimator circuitry 506 is instantiated by programmable circuitry executing execution estimator instructions and/or configured to perform operations such as those represented by the flowchart(s) of FIGS. 9-12.

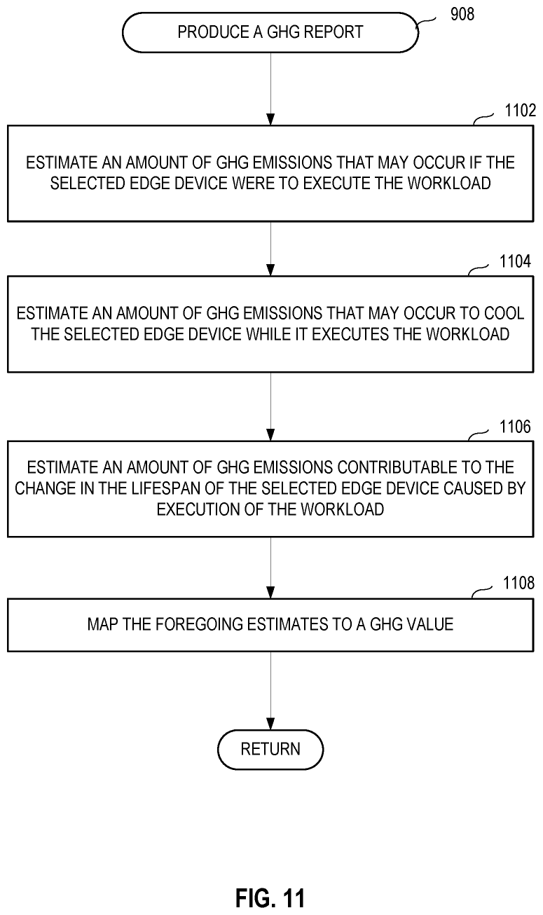

In some examples, the emissions estimator circuitry 404 includes means for estimating GHG emissions that may occur if a selected edge device were to execute a workload. For example, the means for estimating GHG emissions that may occur if a selected edge device were to execute a workload may be implemented by execution estimator circuitry 506. In some examples, the execution estimator circuitry 506 may be instantiated by programmable circuitry such as the example programmable circuitry 1312 of FIG. 13. For instance, the execution estimator circuitry 506 may be instantiated by the example microprocessor 1400 of FIG. 14 executing machine executable instructions such as those implemented by at least blocks 1102 of FIG. 11. In some examples, the execution estimator circuitry 506 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the execution estimator circuitry 506 may be instantiated by any other combination of hardware, software, and/or firmware. For example, the execution estimator circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example cooling estimator circuitry 508 estimates an amount of GHG emissions that may occur to cool the selected edge device 406A while it executes the workload. The example cooling estimator circuitry 508 determines the emissions estimate based on the per component usage metrics in the workload data received from the sandbox circuitry 502. Examples of per component usage metrics include but are not limited to solid state drive (SSD) writes, SSD reads, memory writes, memory reads, memory row hammer factor, core stress, etc. The example cooling estimator circuitry 508 also uses renewable availability data as discussed above and/or telemetry data specific to the selected edge device 406A (e.g., the power dissipation of the selected edge device, the ambient temperature of the selected edge device, etc.) when determining the emissions estimate.

The example cooling estimator circuitry 508 determines a relationship between the foregoing parameters and/or maps the relationship to an output value (e.g., an emissions estimate) using a machine learning model. The example cooling estimator circuitry 508 may implement any type of machine learning model to produce an emissions estimate. In some examples, the cooling estimator circuitry 508 is instantiated by programmable circuitry executing cooling estimator instructions and/or configured to perform operations such as those represented by the flowchart(s) of FIGS. 9-12.

In some examples, the emissions estimator circuitry 404 includes means for estimating GHG emissions that may occur to cool the selected edge device while it executes the workload. For example, the means for estimating GHG emissions that may occur to cool the selected edge device while it executes the workload may be implemented by cooling estimator circuitry 508. In some examples, the cooling estimator circuitry 508 may be instantiated by programmable circuitry such as the example programmable circuitry 1312 of FIG. 13. For instance, the cooling estimator circuitry 508 may be instantiated by the example microprocessor 1400 of FIG. 14 executing machine executable instructions such as those implemented by at least blocks 1104 of FIG. 11. In some examples, the cooling estimator circuitry 508 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the cooling estimator circuitry 508 may be instantiated by any other combination of hardware, software, and/or firmware. For example, the cooling estimator circuitry 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example lifetime estimator circuitry 510 estimates the GHG emissions contributable to the change in the lifespan of the selected edge device 406A that would occur from running the workload. Running a workload may shorten the lifespan of a device and/or cause energy consumption for recycling or waste management operations to occur sooner than it otherwise would have. The reduction in the lifespan of a selected edge device 406A may be further exacerbated if there is a significant time interval before the next maintenance window of the edge device 406A.

In general, sustainability computing efforts include a preference extending product lifespans so that the energy consumption for recycling and/or waste management occurs later in time. However, the example lifetime estimator circuitry 510 also considers that the GHG emissions caused by a given amount of energy consumption is dependent on the proportion of renewable/non-renewable energy sources connected to the power grid at the time of energy consumption. Accordingly, the example lifetime estimator circuitry 510 estimates the GHG emissions based in part on the renewable availability data discussed above. The example lifetime estimator circuitry 510 may also use the per component usage metrics provided by the sandbox circuitry 502 and/or other telemetry data specific to the selected edge device 406A when determining the lifespan impact. Other telemetry data used by the lifetime estimator circuitry 510 may include but is not limited to hardware component ages, device maintenance windows, recycling or waste management options applicable to both the type and/or location of the hardware component, etc.

The example lifetime estimator circuitry 510 determines a relationship between the foregoing parameters and/or maps the relationship to an output value (e.g., a GHG emissions estimate) using a machine learning model. The example lifetime estimator circuitry 510 may implement any type of machine learning model to produce a lifespan impact estimate. The example lifetime estimator circuitry 510 may additionally or alternatively perform amortization calculations to determine the GHG emissions estimate. In some examples, the lifetime estimator circuitry 510 is instantiated by programmable circuitry executing lifetime estimator instructions and/or configured to perform operations such as those represented by the flowchart(s) of FIGS. 9-12.

In some examples, the emissions estimator circuitry 404 includes means for estimating GHG emissions contributable to the change in the lifespan of the selected edge device caused by running the workload. For example, the means for estimating GHG emissions contributable to the change in the lifespan of the selected edge device caused by running the workload may be implemented by lifetime estimator circuitry 510. In some examples, the lifetime estimator circuitry 510 may be instantiated by programmable circuitry such as the example programmable circuitry 1312 of FIG. 13. For instance, the lifetime estimator circuitry 510 may be instantiated by the example microprocessor 1400 of FIG. 14 executing machine executable instructions such as those implemented by at least blocks 1106 of FIG. 11. In some examples, the lifetime estimator circuitry 510 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the lifetime estimator circuitry 510 may be instantiated by any other combination of hardware, software, and/or firmware. For example, the lifetime estimator circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example value determiner circuitry 512 receives the emissions estimate from the execution estimator circuitry 506, the emissions estimate from the cooling estimator circuitry 508, and/or the lifespan impact estimate from the lifetime estimator circuitry 510. The example value determiner circuitry 512 then provides a GHG report to the requesting device (e.g., the client device 402 in FIG. 4A or the resource manager circuitry 408 in FIG. 4B) based on the foregoing estimate. In some examples, the GHG report is implemented as a data structure that includes one or more of: the emissions estimate from the execution estimator circuitry 506, the emissions estimate from the cooling estimator circuitry 508, the lifespan impact estimate from the lifetime estimator circuitry 510, and/or a single value that predicts total GHG emissions based on all three of the foregoing estimates. In examples described herein, the foregoing single value in the GHG report may be referred to as a GHG value. The GHG value can be used as a standardized metric for comparison against other GHG values that correspond to other workload/selected edge device pairing. Accordingly, a GHG value may have any units, an arbitrary unit, or be unitless. In some examples, the units of the GHG value correspond to a monetary cost that will be charged to client device 402 because of the GHG emissions caused by submitting the workload.

Advantageously, the client device 402 or the resource manager circuitry 408 can use any combination of parameters within a GHG report (e.g., can consider scope 2 emissions and/or scope 3 emissions either collectively or independently) when determining where to assign a workload. In some examples, the value determiner circuitry 512 is instantiated by programmable circuitry executing value determiner instructions and/or configured to perform operations such as those represented by the flowchart(s) of FIGS. 9-12.

In some examples, the value determiner circuitry 512 also considers scope 1 emissions when determining a GHG report. Scope 1 emissions refers to GHG emissions that occur from sources that an organization owns or controls directly (e.g., the usage of fuel in trucks that transport products from: a) a manufacturing plant to a distribution center, and/or b) from a distribution center to a consumer). As such, the value determiner circuitry 512 may add a fixed offset to the total GHG emissions value to represent scope 1 emissions because scope 1 emissions are not specific to any one compute device or workload.

In some examples, the emissions estimator circuitry 404 includes means for mapping GHG emissions estimate to a value. For example, the means for mapping GHG emissions estimate to a value may be implemented by value determiner circuitry 512. In some examples, the value determiner circuitry 512 may be instantiated by programmable circuitry such as the example programmable circuitry 1312 of FIG. 13. For instance, the value determiner circuitry 512 may be instantiated by the example microprocessor 1400 of FIG. 14 executing machine executable instructions such as those implemented by at least blocks 1108 of FIG. 11. In some examples, the value determiner circuitry 512 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the value determiner circuitry 512 may be instantiated by any other combination of hardware, software, and/or firmware. For example, the value determiner circuitry 512 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example model adjuster circuitry 514 receives the feedback data from the edge device 406A that was assigned the workload. The example model adjuster circuitry 514 then compares the measured emissions data from the feedback data to the estimated emissions data of the execution estimator circuitry 506 and/or the cooling estimator circuitry 508. The example model adjuster circuitry 514 may adjust one or more model parameters associated with the execution estimator circuitry 506 or the cooling estimator circuitry 508 if the difference between the measured emissions data and/or the estimated emissions data is greater in magnitude than a threshold value. In some examples, the lifetime estimator circuitry 510 is instantiated by programmable circuitry executing lifetime estimator instructions and/or configured to perform operations such as those represented by the flowchart(s) of FIGS. 9-12.

In some examples, the emissions estimator circuitry 404 includes means for adjusting a model that estimates GHG emissions. For example, the means for adjusting a model that estimates GHG emissions may be implemented by model adjuster circuitry 514. In some examples, the model adjuster circuitry 514 may be instantiated by programmable circuitry such as the example programmable circuitry 1312 of FIG. 13. For instance, the model adjuster circuitry 514 may be instantiated by the example microprocessor 1400 of FIG. 14 executing machine executable instructions such as those implemented by at least blocks 914 of FIG. 9. In some examples, the model adjuster circuitry 514 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the model adjuster circuitry 514 may be instantiated by any other combination of hardware, software, and/or firmware. For example, the model adjuster circuitry 514 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The example value determiner circuitry 512 makes the estimated emissions per unit of non-wasteful computations directly available in the GHG report and/or uses the estimates to form the total GHG value in the GHG report. Accordingly, by exposing an API interface to access one or more values in the GHG report data structure, the example emissions estimator circuitry 404 can report its estimates to a GHG-aware scheduling system (e.g., the client device 402 in FIG. 4A or the resource manager circuitry 408 in FIG. 4B) that takes the GHG report into account when assigning workloads.

Having GHG emissions expressed in both operational costs (e.g., emissions estimated from the execution estimator circuitry 506 and/or the cooling estimator circuitry 510) and/or the longer-term proportion of embodied costs (e.g., emissions estimated from the lifetime estimator circuitry 510) offers a GHG-aware scheduling system the ability to drive different choices. For example, when an energy source is carbon intensive (e.g., brown energy), selecting resources that have lower operational emissions (as estimated by the execution estimator circuitry 506 and/or the cooling estimator circuitry 508) may be beneficial. Conversely, when the energy source is green, selecting resources with lower embodied emissions (as estimated by the lifetime estimator circuitry 510) may be better, even if such a selection results in higher energy consumption at present to complete the task at hand. The GHG-aware scheduling system may additionally consider other load-balancing factors including but not limited to utilization, latency, etc.

In some examples, the resource manager circuitry 408 uses GHG reports to assign and/or adjust workloads to the edge devices 406 in a manner that increases sustainability across a group of workloads. For example, suppose the client device 402 submits a first workload and/or a second client device submits a second workload to the resource manager circuitry 408. Suppose further that the emission estimator circuitry 404 estimates a GHG value of 200 for the first workload and/or a GHG value of 300 for the second workload, respectively.

Suppose further that the resource manager circuitry 408 encounters a scheduling decision for two GPUs within the edge devices 406 during the execution of the workloads. In particular, the first workload caused 250 units of GHG value emissions, and/or B caused only 150 units of GHG value emissions, at the time the scheduling decision is reached. In such an example, the resource manager circuitry 408 may consider the facts that: a) the first workload is causing 50 units of GHG value more than expected, and/or b) the second workload has emitted 150 units of GHG value less than expected while determining what workloads (if any) to assign or re-assign to the GPUs.

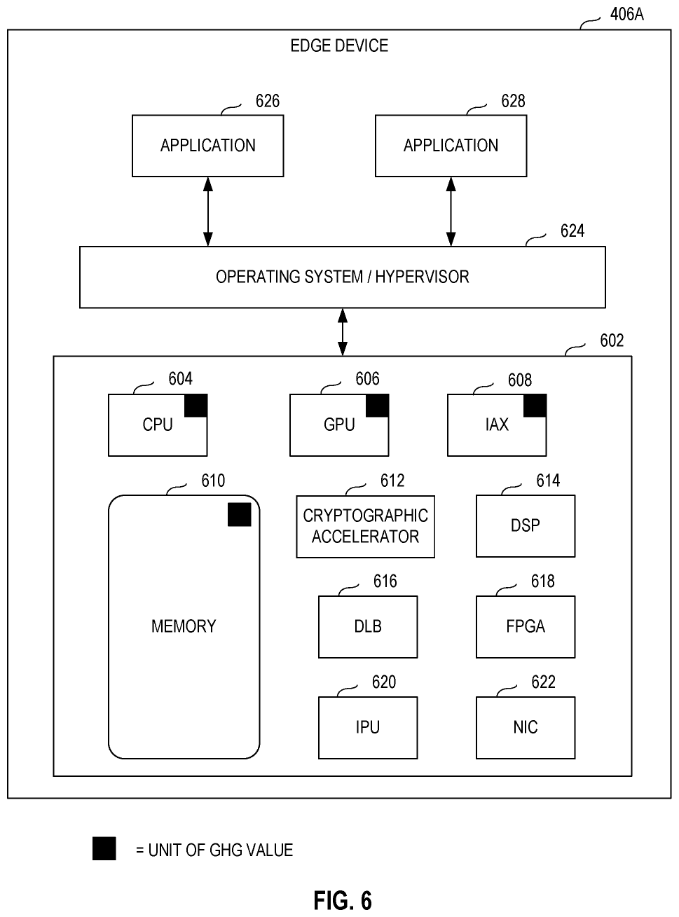

FIG. 6 is a block diagram of an example implementation of an edge device of FIG. 4. The example edge device 406A includes example hardware components 602. The example hardware components 602 includes an example CPU 604, an example GPU 606, example Integrated In-Memory Database Accelerator (IAX) circuitry 608, example memory 610, example cryptographic accelerator circuitry 612 (e.g., an Intel® QuickAssist Technology (QAT) device), an example DSP 614, example Dynamic Load Balancer (DLB) circuitry 616, an example FPGA 618, an example Infrastructure Processor Unit (IPU) circuitry 620, and/or example Network Interface Card (NIC) circuitry 622. The example edge device 406A also includes an example operating system 624 and/or example applications 626A and/or 626B.

A given edge device may include a variety of different hardware components. Accordingly, the execution of a workload may lead to power consumption from some but not all the hardware components 602 running on an edge device. In the example of FIG. 6, the workload causes the CPU 604, the GPU 606, the IAX circuitry 608 and/or the memory 610 to consume power, while the example cryptographic accelerator circuitry 612, the example DSP 614, the example DLB circuitry 616, the example FPGA 618, the example IPU circuitry 620, and/or the example NIC circuitry 622 do not consume power due to the workload. Accordingly, the example emission estimator circuitry 404 considers GHG emissions based on the CPU 604, the GPU 606, the IAX circuitry 608 and/or the memory 610. In some examples, the operating system 624, the application 626, and/or the application 628 influences which of the hardware components 602 are utilized (e.g., consume power) while implementing the workload. As used above and/or herein, hardware components may additionally or alternatively be referred to as hardware circuits.

Advantageously, the example emission estimator circuitry 404 sample and/or estimate carbon GHG based on telemetry metrics of the individual hardware components 602. The example edge device 406A provides telemetry data with timestamps. Accordingly, the example emission estimator circuitry 404 uses the timestamps to align and/or attribute telemetry data to resource execution so that precise attribution can be made. The example emission estimator circuitry 404 may use proportional integral derivative (PID) controllers to perform one or more telemetry alignment operations.

In some examples, the collection and/or analysis of component specific telemetry metrics enables the emissions estimator circuitry 404 to issue GHG reports that estimate GHG emissions for particular hardware components within the selected edge device. Accordingly, a GHG-aware scheduling system may use a GHG report to sustainably assign workloads to a particular component(s) within the selected edge device.

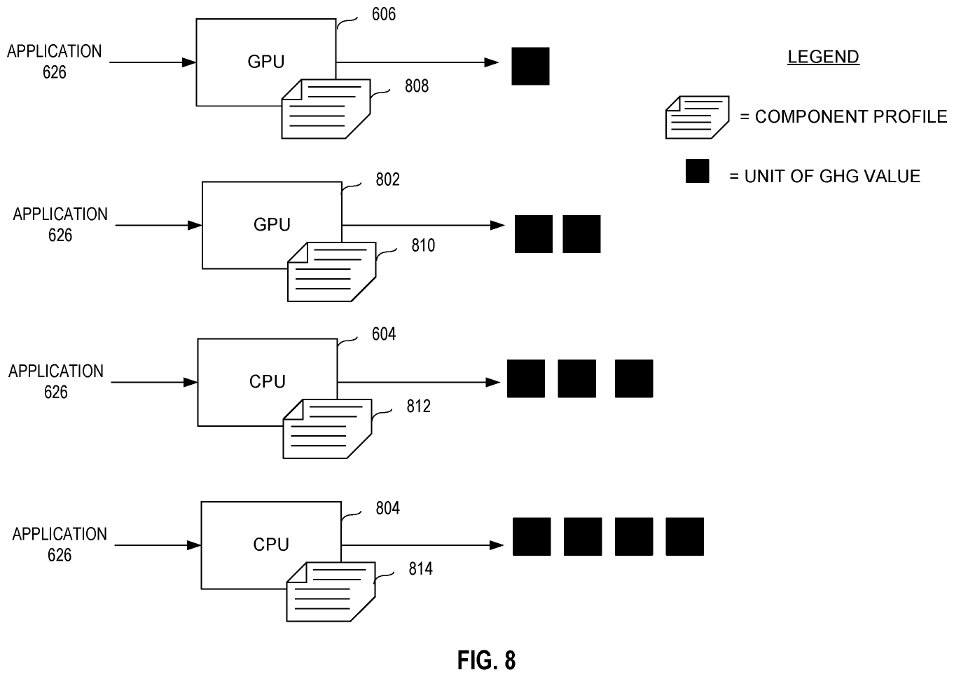

For example, suppose a video analytic application is more performant (e.g., operates at a higher computational efficiency) in the GPU 606 rather than CPU 604. However, the emissions estimator circuitry 404 may indicate the CPU 604 would cause fewer GHG emissions than the GPU 606 with respect to the workload. The difference in GHG emissions may be caused by any number of factors, including but not limited to the relative age of the CPU 604 and/or GPU 606, the proximity of the components to a colling source within the edge device 406A, the component profiles of the CPU 604 and/or GPU 606, etc. Component profiles are discussed further in connection with FIG. 8. In such an example, a GHG-aware scheduling system (e.g., the client device 402 in FIG. 4A or the resource manager circuitry 408 in FIG. 4B) may decide, based on the GHG report, to assign the workload to the CPU 604 despite experiencing a loss in computational efficiency (e.g., the workload requires more time to complete) when compared to the GPU 606.

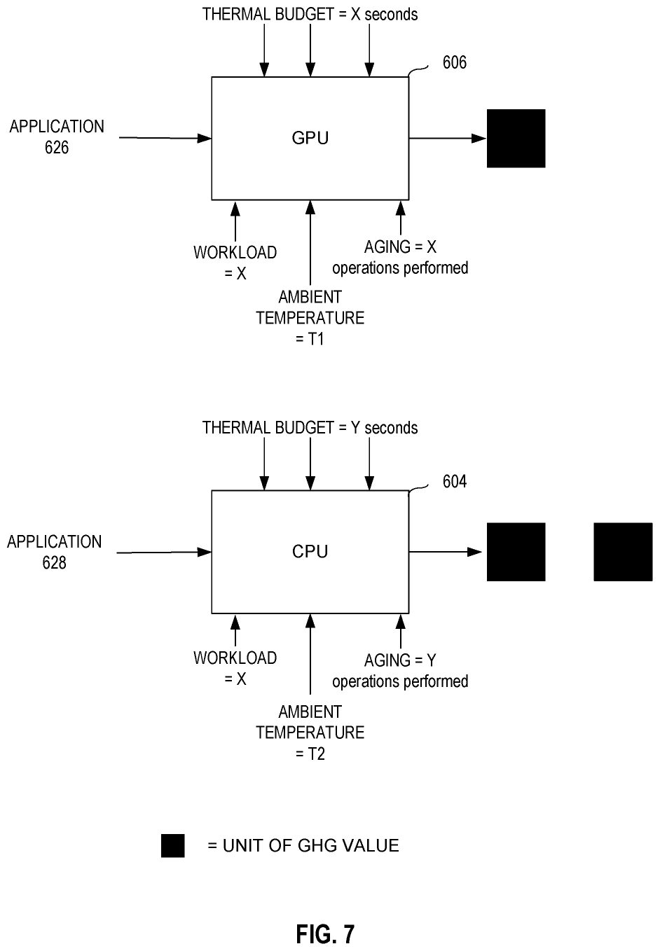

FIG. 7 is an illustrative example of variables that influence the GHG emissions contributable to a compute component. FIG. 7 shows the example GPU 606 and/or the example CPU 604 of FIG. 6.

Various factors influence the GHG emissions of a workload during runtime. For example, temperature can significantly affect the amount of power consumed and/or therefore affect the magnitude amount of GHG emissions. Temperature can fluctuate frequently, particularly in an edge environment where the selected edge device 406A may not be located within a temperature-controlled data center.

Variations in temperature may cause an initial estimate produced by the emissions estimator circuitry 404 to differ from actual usage. For example, suppose a workload that runs on a virtual machine on the selected edge device 406A for two days, at four hours per day, results in a total GHG value of 100. The example emissions estimator circuitry 404 outputs the 100 GHG value based on an average temperature of the edge device 406A expected at that time.

If an unexpected weather event occurs, or if the edge device 406A executes the workload only at night when temperatures are lower, cooling costs may differ, and/or the GHG emissions may be less than originally estimated. For example, the actual emissions caused by the workload may be represented with a total GHG value of 90. In some examples, a GHG-aware scheduling system (e.g., the client device 402 in FIG. 4A and/or the resource manager circuitry 408 in FIG. 4B) notices the GHG value was 10 units less than expected and/or issues a credit based on the difference.

Furthermore, factors that influence GHG emissions will vary based on the hardware components 602 within the selected edge device 406A that consume power in the workload. For example, suppose the GPU 606 of FIG. 6 executes a particular application 626 to implement the workload. The GPU 606 also has a particular ambient temperature, a particular age, and/or a particular thermal budget (e.g., a maximum amount of time that the GPU 606 can operate above a threshold temperature, as determined by the operating system 624) while implementing the workload. In the example of FIG. 7, the specific values of the foregoing parameters result in a determination that the GPU 606 caused one unit of GHG value (as described above in connection with FIG. 5) to implement the workload.

At the same time the GPU 606 is implementing the workload as described above, the example CPU 604 is also implementing the workload. The CPU 604 may be operating at a different ambient temperature than the GPU 606 (e.g., one of the hardware components is located closer to a cooling mechanism within the edge device 406A than the other component). Similarly, the CPU 604 may run a different application 628, have a different age, and/or have a different thermal budget than the GPU 606 while implementing the same workload. In the example of FIG. 7, the specific values of the foregoing parameters result in a determination that the CPU 604 caused two units of GHG value to implement the workload.

FIG. 8 is an illustrative example of how component profiles influence the GHG emissions contributable to a compute component. FIG. 8 includes the example CPU 604, the example GPU 606, and/or the example application 626 of FIG. 6. FIG. 8 also includes an example GPU 802, an example CPU 804, and/or example component profiles 808, 810, 812, 814.

The component profiles 808, 810, 812, 814, describe the relationship that a respective hardware component has between internal characteristics of the component and/or the scale of GHG emissions caused by the component. For example, some memory technologies (e.g., Solid State Drives (SSDs) or phase change memory drives) will have higher GHG emissions than other memory technologies (e.g., NAND/OR flash memory) due to the relative use of write and/or read operations. In general, write operations may consume upwards of five times more power than read operations (because a property of a storage material, e.g., amorphous vs crystalline, changes during a write operation). The relationship between writes, reads, and/or power consumption is different for each of SSDs, phase change memory drives, and/or NAND/OR flash memory. Accordingly, implementing a workload will cause different amounts of GHG emissions depending on the type of memory used.

Like the example FIG. 7, the GPU 606 executes the application 626 and/or causes one unit of GHG value in FIG. 8. In the example of FIG. 8, GPU 606 causes the one unit of GHG value based on internal characteristics described in the component profile 808. Accordingly, when a different GPU 802 with a different component file 810 executes the same application 626, the GPU 202 causes a different amount of emissions (e.g., two units of GHG value). Similarly, FIG. 8 shows that, despite the example CPU 604 and/or the example CPU 804 both executing the application 626, the CPU 604 causes a different amount of emissions (3 units of GHG value) than the CPU 804 does (4 units of GHG value) because of the differences in the component profiles 812 and/or 814.

The example network interface circuitry 501 of FIG. 5 obtains component profiles from any source (e.g., from device manufacturers, from internal testing, etc.). Besides the relationship between read, writes, and/or power consumption, one or more of the component profiles may additionally or alternatively describe a component specific relationship between temperature and/or power consumption, power required for cooling for that specific component at various load levels and/or temperatures, etc.

Within the emissions estimator circuitry 404, one or more machine learning models from the example execution estimator circuitry 506, the example cooling estimator circuitry 508, and/or the example lifetime estimator circuitry 510 use the component profiles to generate various emissions estimates. In general, the total GHG emissions contributable to a hardware component may be modeled as a function that includes inputs from the component profiles. For example, the GHG emissions of a Powertrain Control Module (PCM) drive can be determined in part by a function of component specific characteristics including write bandwidth, read bandwidth, ambient temperature, interleave factor, and/or wear level thresholding. The GHG emissions of the PCM drive (and/or more generally, any hardware component) are also based on the current telemetry of the hardware component, the availability of renewable energy, and/or characteristics of the workload as discussed above in connection with FIG. 5.

While an example manner of implementing the emission estimator circuitry 404 and/or GHG-aware scheduling system of FIG. 1 is illustrated in FIGS. 4A and/or 4B, one or more of the elements, processes, and/or devices illustrated in FIGS. 4A and/or 4B may be combined, divided, re-arranged, omitted, eliminated, and/or implemented in any other way. Further, the example sandbox circuitry 502, the example multiplexer 504, the example execution estimator circuitry 506, the example cooling estimator circuitry 508, the example lifetime estimator circuitry 510, the example model adjuster circuitry 514, and/or, more generally, the example emission estimator circuitry 404 and/or GHG-aware scheduling system of FIGS. 4A and/or 4B, may be implemented by hardware alone or by hardware in combination with software and/or firmware. Thus, for example, any of the example sandbox circuitry 502, the example multiplexer 504, the example execution estimator circuitry 506, the example cooling estimator circuitry 508, the example lifetime estimator circuitry 510, the example model adjuster circuitry 514, and/or, more generally, the example emission estimator circuitry 404 and/or GHG-aware scheduling system, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example emission estimator circuitry 404 and/or GHG-aware scheduling system of FIGS. 4A and/or 4B may include one or more elements, processes, and/or devices in addition to, or instead of, those illustrated in FIGS. 4A and/or 4B, and/or may include more than one of any or all of the illustrated elements, processes and/or devices.

Flowchart(s) representative of example machine-readable instructions, which may be executed by programmable circuitry to implement and/or instantiate the emission estimator circuitry 404 and/or GHG-aware scheduling system of FIGS. 4A and/or 4B and/or representative of example operations which may be performed by programmable circuitry to implement and/or instantiate the emission estimator circuitry 404 and/or GHG-aware scheduling system of FIGS. 4A and/or 4B, are shown in FIGS. 9-12. The machine-readable instructions may be one or more executable programs or portion(s) of one or more executable programs for execution by programmable circuitry such as the programmable circuitry 1312 shown in the example programmable circuitry platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and/or a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and/or an endpoint client hardware device. Similarly, the non-transitory computer readable storage medium may include one or more mediums. Further, although the example program is described with reference to the flowchart(s) illustrated in FIGS. 9-12, many other methods of implementing the example emission estimator circuitry 404 and/or GHG-aware scheduling system may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and/or stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 9-12 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and/or to exclude propagating signals and/or to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and/or “non-transitory machine-readable storage device” are defined to include any physical (mechanical, magnetic and/or electrical) hardware to retain information for a time period, but to exclude propagating signals and/or to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement the emissions estimator circuitry 404 of FIG. 4. The example machine-readable instructions and/or the example operations 900 begin when the network interface circuitry 501 obtains a workload and/or a selected edge device. (Block 902). In some examples, the emissions estimator circuitry 404 obtains both the workload and/or the selected edge device from the same source (e.g., the client device 402 in FIG. 4A, the resource manager circuitry 408 in FIG. 4B, etc.). In other examples, the network interface circuitry 501 obtains the workload from a different source than the selected edge device. In some examples, the network interface circuitry 501 uses one or more API calls to implement block 902.

The example sandbox circuitry 502 determines compute scalability and/or component usage estimates of the workload. (Block 904). To do so, the sandbox circuitry 502 runs the workload in a sandbox environment (e.g., an isolated virtual machine) to measure various performance metrics of the workload as discussed above in connection with FIG. 5.

The example network interface circuitry 501 obtains device specific parameters. (Block 906). The device specific parameters of block 906 may refer to any value that influence the magnitude of GHG emissions contributable to running the workload on the selected edge device 406A. The parameters obtained by the example network interface circuitry 501 may depend on factors including but not limited to the internal structure of the selected edge device 406A, the location of the edge device 406A, etc.

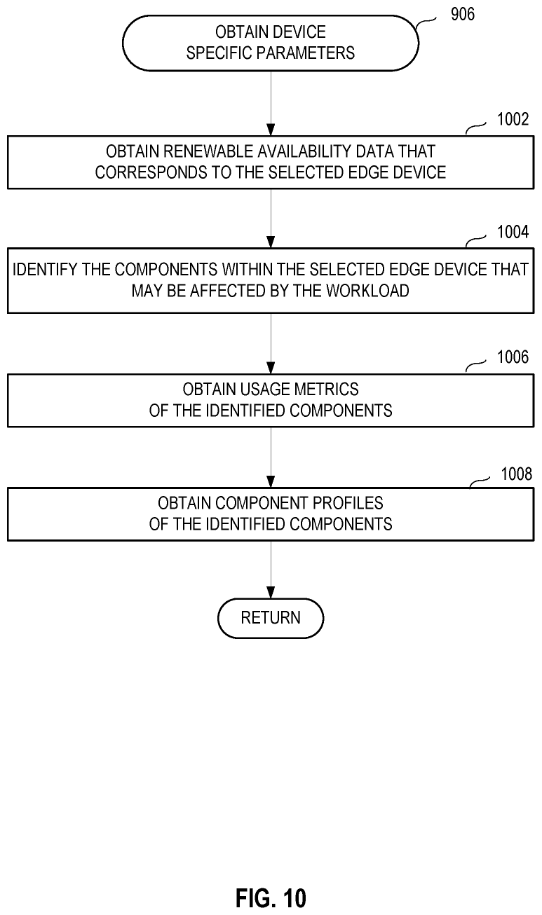

In some examples, the network interface circuitry 501 obtains the device specific parameters of block 906 using one or more API calls to communicate with the edge devices 406. Additionally or alternatively, the example network interface circuitry 501 obtains one or more device specific parameters through a telemetry stream. For example, the network interface circuitry 501 may transmit an API request that invokes or initiates an edge device 406A to transmit a stream of telemetry data from to the emissions estimator circuitry 404. A telemetry stream may include the transmission of telemetry data at any frequency and/or period. Additionally or alternatively, a telemetry stream may refer to any number of aperiodic transmissions of telemetry data. Block 906 is discussed further in connection with FIG. 10.

The example emissions estimator circuitry 404 produces a GHG report. (Block 908). In some examples, the GHG report is a data structure that provides one or more metrics that estimate GHG emissions contributable to running the workload on the selected edge device 406A. The example emissions estimator circuitry 404 produces the GHG report (e.g., implements block 908) using one or more of the compute scalability metrics of block 904, the component usage estimates of block 904, and/or the device specific parameters of block 906. Block 908 is discussed further in connection with FIG. 11.

The example emissions estimator circuitry 404 provides the GHG report to a requesting device. (Block 910). In some examples, the device requesting the GHG report is the same device submitting the workload and/or submitting the edge device. In other examples, the emissions estimator circuitry 404 provides the GHG report to a different device. The GHG report enables a GHG-aware scheduling system to assign the workload to an edge device 406 in a sustainable manner.

The emissions estimator circuitry 404 may provide one or more components of the GHG report at block 910 to the requesting device using API calls. Additionally or alternatively, the GHG report may be part of a telemetry stream in which data is transmitted from multiple devices in the edge cloud 110 and/or received by a GHG-aware scheduling system. For example, in FIG. 4B, the resource manager circuitry 408 may transmit a first API request to an edge devices 406A for telemetry data and/or a second API request to the emissions estimator circuitry 404 requesting a corresponding GHG report. The one or more transmissions used to provide the telemetry data and/or GHG report may be collectively referred to as a telemetry steam. In such examples, the emissions estimator circuitry 404 may also transmit an API response at block 910 that indicates the telemetry stream has been initiated (e.g., invoked).

The example emissions estimator circuitry 404 determines whether the workload was assigned to the selected edge device. (Block 912). To do so, the emissions estimator circuitry 404 may request feedback data from the selected edge device 406A. In some examples, a lack of response from the selected edge device 406A indicates the edge device 406A was not assigned the workload and/or therefore has no feedback data to provide. Similarly, a response from the selected edge device 406A may indicate the edge device 406A was assigned the workload.

In other examples, one or more of the edge devices 406 provide performance data to the emissions estimator circuitry 404 in a telemetry stream. In such an example, the emissions estimator circuitry 404 may identify the executed workload in the telemetry stream at block 912 and/or determine whether a corresponding GHG report was previously produced.

If the workload was assigned to the selected device (Block 912: Yes), the example model adjuster circuitry 514 optionally adjusts one or more models based on the feedback data. (Block 914). For example, the model adjuster circuitry 514 may compare measured emissions data from the telemetry feedback to estimated emissions data of the GHG report. The example model adjuster circuitry 514 may then adjust one or more model parameters associated with the execution estimator circuitry 506 or the cooling estimator circuitry 508 if the difference between the measured emissions data and/or the estimated emissions data is greater in magnitude than a threshold value. In some examples, the execution estimator circuitry 506 or the cooling estimator circuitry 508 correspond to separate threshold values and/or are therefore updated independently from one another. Alternatively, if the workload was not assigned to the selected edge device (Block 912: No), the machine-readable instructions and/or operations 900 end.

FIG. 10 is a flowchart representative of example machine-readable instructions and/or example operations that may be executed, instantiated, and/or performed by example programmable circuitry to obtain device specific parameters as described in connection with FIG. 9. In particular, the flowchart of FIG. 10 is an example implementation of block 906 of FIG. 9.

Execution of block 906 begins when network interface circuitry 501 obtains renewable availability data that corresponds to the selected edge device 406A. (Block 1002). As used above and/or herein, renewable availability data refers to data that characterizes the amount and/or type of renewable energy available for use to power or cool a given device during execution of the workload. In some examples, renewable availability data is provided by a GHG-density service as described above in connection with FIG. 5. In some examples, the network interface circuitry 501 uses one or more API calls to implement block 1002.

The example emissions estimator circuitry 404 identifies the components within the selected edge device 406A that may be affected by the workload. (Block 1004). For example, in FIG. 6, the workload would cause the CPU 604, the GPU 606, the IAX circuitry 608, and/or the memory 610 to consume power. Accordingly, the example emissions estimator circuitry 404 may identify the foregoing components at block 1004 but not identify the remaining hardware components 602.

The example network interface circuitry 501 obtains usage metrics of the identified components. (Block 1006). Such usage metrics may include but are not limited to values that represent the thermal budget, age of the component, and/or ambient temperature at the time the hardware component would execute the workload. In some examples, the emissions estimator circuitry 404 obtains additional component specific usage metrics at block 1006. In some examples, the network interface circuitry 501 uses one or more API calls to implement block 1006.

The example network interface circuitry 501 obtains component profiles of the identified components. (Block 1008). The component profiles represent the relationship that a respective hardware component has between internal characteristics of the component and/or the scale of GHG emissions caused by the component. The component profiles may describe any type of component characteristic and/or may come from any source as discussed above in connection with FIG. 8.

In some examples, the network interface circuitry 501 obtains other telemetry data in addition to the data described in connection with blocks 1002-1008. Examples of other telemetry data used to form GHG estimates include but are not limited to computational efficiency, device utilization, etc. In some examples, the network interface circuitry 501 uses one or more API calls to implement block 1008. The example machine-readable instructions and/or example operations 900 return to block 908 after 1008.

FIG. 11 is a flowchart representative of example machine-readable instructions and/or example operations that may be executed, instantiated, and/or performed by example programmable circuitry to produce a GHG report as described in connection with FIG. 9. In particular, the flowchart of FIG. 11 is an example implementation of block 908 of FIG. 9.

Execution of block 908 begins when the example execution estimator circuitry 506 estimates an amount of GHG emissions that may occur if the selected edge device were to execute the workload. (Block 1102). The example emissions estimator circuitry 404 may implement any type of machine learning model to generate an emissions estimate as discussed above in connection with FIG. 5. The execution estimator model may use inputs including but not limited to a core scalability factor, component scalability factor, frequency scalability factor, the number of processor cores of the selected edge device, the processor frequency of the selected edge device, thermal budget, renewable availability data, component profiles, etc., from blocks 904 and/or 906 to generate the emissions estimate. In some examples, the execution estimator model additionally or alternatively uses other factors to determine the estimate.

The example cooling estimator circuitry 508 estimates an amount of GHG emissions that may occur to cool the selected edge device while it executes the workload. (Block 1104). The example cooling estimator circuitry 508 may implement any type of machine learning model to generate an emissions estimate as discussed above in connection with FIG. 5. The cooling estimator model may use inputs including but not limited to memory writes, memory reads, memory row hammer factor, core stress, power dissipation, ambient temperature, thermal budget, renewable availability data, component profiles, etc., from blocks 904 and/or 906 to generate the emissions estimate. In some examples, the cooling estimator model additionally or alternatively uses other factors to determine the estimate.

The example lifetime estimator circuitry 510 estimates an amount of GHG emissions contributable to the change in the lifespan of the selected edge device caused by execution of the workload. (Block 1106). The example emissions estimator circuitry 404 may implement any type of machine learning model to generate an emissions estimate as discussed above in connection with FIG. 5. The lifetime estimator model may use inputs including but not limited to per component usage metrics, hardware component ages, device maintenance windows, renewable availability data for the period when one or more components are anticipated to reach their end of life, recycling or waste management options applicable to both the type and/or location of the hardware component, etc., from blocks 904 and/or 906 to generate the emissions estimate. In some examples, the lifetime estimator model additionally or alternatively uses other factors to determine the estimate.

The example value determiner circuitry 512 maps the foregoing estimates to a GHG value. (Block 1108). In examples used herein, the GHG value is a positive integer that increases in proportion with the sum of the emissions estimates. In other examples, the GHG value refers to another unit of measurement that can be used for comparison against other GHG values.

The GHG report provided by the emissions estimator circuitry 404 at block 910 at collectively refers to: a) the emissions estimate of block 1102, b) the emissions estimate of block 1104, c) the emissions estimate of block 1106, and/or d) the GHG value of block 1108. Accordingly, a GHG-aware scheduling system can use one or more factors from a GHG report to assign workloads. The example machine-readable instructions and/or example operations 900 return to block 910 after block 1108.

FIG. 12 is a flowchart representative of example machine-readable instructions and/or example operations that may be executed, instantiated, and/or performed by example programmable circuitry to implement the resource manager circuitry 408 of FIG. 4B. More generally, the example flowchart of FIG. 12 may be used to implement any GHG-aware scheduling system.

The example machine-readable instructions and/or example operations 1200 begin when the resource manager circuitry 408 obtains a workload. (Block 1202). The workload may be submitted by any use case, end point, workstation, node, etc. in communication with the edge cloud 110. In the example of FIG. 4B, the workload is submitted by the client device 402.

The example resource manager circuitry 408 identifies an edge device capable of running the workload. (Block 1204). The identified edge device may include any device executing remotely submitted workloads as part of a cloud computing architecture. In the example of FIG. 4B, the resource manager circuitry 408 identifies one such device from the edge devices 406. In other examples, a different device (e.g., the client device 402) selects an edge device and/or provides the selection to the resource manager circuitry 408.

The example resource manager circuitry 408 obtains a GHG report. (Block 1206). As discussed above, the GHG report estimates emissions for running the workload on the identified edge device. The resource manager circuitry 408 may use any number of API calls to request and/or subsequently receive a GHG report from the emissions estimator circuitry 404.

The example resource manager circuitry 408 determines whether to obtain another GHG report. (Block 1208). The example resource manager circuitry 408 may obtain another GHG report for any reason. For example, the resource manager circuitry 408 may assign multiple workloads to the edge devices 406 as a group. In such examples, the resource manager circuitry 408 may use multiple GHG reports to assign the multiple workloads in a sustainable manner.

The example resource manager circuitry 408 may also obtain more than one GHG report per workload. For example, a first GHG report estimates emissions if the workload is executed on edge device 406A, while as second estimates emissions if the workload is executed on edge device 406B, etc. The example resource manager circuitry 408 may obtain GHG reports for any combination of workloads and/or edge devices 406.

If the example resource manager circuitry 408 decides to obtain another GHG report (Block 1208: Yes), control returns to block 1202 where the resource manager circuitry 408 obtains a workload. The resource manager circuitry 408 may obtain the same or a different workload from the workload obtained in the previous iteration of block 1202.

If the example resource manager circuitry 408 decides to not obtain another GHG report (Block 1208: No), the resource manager circuitry 408 optionally determines other load-balancing factors. (Block 1210). Other load balancing factors may include but are not limited to utilization, latency, etc.

The example resource manager circuitry 408 assigns the one or more workloads based on the one or more GHG reports and/or the available factors from block 1210. (Block 1212). The example resource manager circuitry 408 may assign the workloads as part of any suitable cloud computing architecture (e.g., IaaS, PaaS, SaaS, FaaS, etc.).

In some examples, the resource manager circuitry 408 uses the GHG reports to balance sustainable computing efforts against other factors. For example, computational efficiency (e.g., the amount of time or memory required to execute a workload) may be inversely proportional to emissions because a devices consumes more power to complete a workload quickly (e.g., through multi-threading or over-clocking). Accordingly, the resource manager circuitry 408 may assign a workload to an edge device 406A that is less computationally efficient than another edge device 406B because GHG reports indicate the edge device 406A will result in fewer GHG emissions.

The example resource manager circuitry 408 determines whether to consider adjusting one or more of the workload assignments. (Block 1214). A workload assignment may be adjusted for any reason. In some examples, any of the submission of new workloads, the movement of an edge device from one location to another, or a change in the renewable energy sources available to a region, may cause the resource manager circuitry 408 to adjust a pre-existing workload assignment.

For instance, suppose the edge devices 406B, 406C, and/or 406D are powered by energy from brown hydrogen (e.g., hydrogen derived from coal) while the edge device 406A is powered by energy from blue hydrogen (e.g., hydrogen derived from natural gas). Accordingly, the resource manager circuitry 408 may initially assign a workload to edge device 406A based on GHG reports that indicate the edge device 406A will cause fewer GHG emissions. Suppose further that, during the execution, a new edge device 406E, powered by green hydrogen (e.g., hydrogen derived from renewable resources) joins the edge cloud 110. In such examples, the resource manager circuitry 408 may consider adjusting the workload assignment (e.g., re-assigning the workload) because execution on the edge device 406E may lead to fewer GHG emissions.

If the resource manager circuitry 408 does consider adjusting the workload assignment(s), control returns to block 1214 where the resource manager obtains a workload (e.g., the already assigned workload). By looping to the beginning of the flowchart, the resource manager circuitry 408 can obtain new GHG report(s) for use in determining whether to make an adjustment. The new GHG report(s) may correspond to a new edge device (like the edge device 406E described in the foregoing example) or provide updates to older GHG reports based on changes to temperature, renewable availability, and/or other telemetry data. If the resource manager circuitry 408 does not consider adjusting the workload assignment(s), the example machine-readable instructions and/or operations 900 end.

FIG. 13 is a block diagram of an example programmable circuitry platform 1300 structured to execute and/or instantiate the example machine-readable instructions and/or the example operations of FIGS. 9-12 to implement the emission estimator circuitry 404 and/or GHG-aware scheduling system of FIGS. 4A and/or 4B. The programmable circuitry platform 1300 can be, for example, a server, a personal computer, a workstation, a self-learning machine (e.g., a neural network), a mobile device (e.g., a cell phone, a smart phone, a tablet such as an iPad™), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example sandbox circuitry 502, the example multiplexer 504, the example execution estimator circuitry 506, the example cooling estimator circuitry 508, the example lifetime estimator circuitry 510, and/or the example model adjuster circuitry 514. In other examples, the programmable circuitry 1312 may implement the example client device 402, one or more of the edge devices 406, or the example resource manager circuitry 408.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and/or a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and/or from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 9-12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIG. 2 as logic circuits to perform operations corresponding to those machine-readable instructions. In some such examples, the circuitry of FIGS. 4A and/or 4B is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and/or executed in parallel by two or more of the cores 1402. The software program may correspond to a portion or all of the machine-readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and/or an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and/or the shared memory 1410 may be part of a hierarchy of storage devices including multiple levels of cache memory and/or the main memory (e.g., the main memory 1314, 1316 of FIG. 13). Typically, higher levels of memory in the hierarchy exhibit lower access time and/or have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and/or logic (AL) circuitry (sometimes referred to as an ALU) 1416, a plurality of registers 1418, the local memory 1420, and/or a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer-based operations. In other examples, the AL circuitry 1416 also performs floating-point operations. In yet other examples, the AL circuitry 1416 may include first AL circuitry that performs integer-based operations and/or second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and/or described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and/or FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 9-12 but whose interconnections and/or logic circuitry are fixed once fabricated), the FPGA circuitry 1500 of the example of FIG. 15 includes interconnections and/or logic circuitry that may be configured, structured, programmed, and/or interconnected in different ways after fabrication to instantiate, for example, some or all of the operations/functions corresponding to the machine-readable instructions represented by the flowchart(s) of FIGS. 9-12. In particular, the FPGA circuitry 1500 may be thought of as an array of logic gates, interconnections, and/or switches. The switches can be programmed to change how the logic gates are interconnected by the interconnections, effectively forming one or more dedicated logic circuits (unless and/or until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine-readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and/or the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and/or example storage circuitry 1512. The logic gate circuitry 1508 and/or the configurable interconnections 1510 are configurable to instantiate one or more operations/functions that may correspond to at least some of the machine-readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And/or gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and/or increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and/or multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and/or 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and/or the example FPGA circuitry 1500 of FIG. 15. In some such hybrid examples, one or more cores 1402 of FIG. 14 may execute a first portion of the machine-readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIGS. 9-12, and/or an ASIC may be configured and/or structured to perform third operation(s)/function(s) corresponding to a third portion of the machine-readable instructions represented by the flowcharts of FIGS. 9-12.

It should be understood that some or all of the circuitry of FIGS. 4A and/or 4B may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 4A and/or 4B may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 4A and/or 4B may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and/or an FPGA (e.g., the FPGA circuitry 1500 of FIG. 15) in still yet another package.

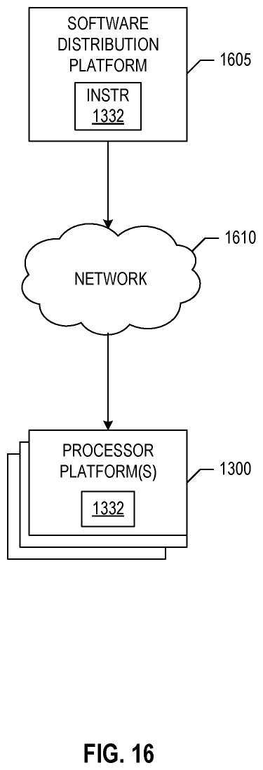

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and/or transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and/or one or more storage devices. The storage devices store the machine-readable instructions 1332, which may correspond to the example machine-readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1332 from the software distribution platform 1605. For example, the software, which may correspond to the example machine-readable instructions of FIGS. 9-12, may be downloaded to the example programmable circuitry platform 1300, which is to execute the machine-readable instructions 1332 to implement the emission estimator circuitry 404 and/or GHG-aware scheduling system. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and/or applied to the software at the end user devices. Although referred to as software above, the distributed “software” could alternatively be firmware.

“Including” and/or “comprising” (and/or all forms and/or tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and/or “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and/or with C. As used herein in the context of describing structures, components, items, objects and/or things, the phrase “at least one of A and/or B” is intended to refer to implementations including any of (1) at least one A, (2) at least one B, or (3) at least one A and/or at least one B. Similarly, as used herein in the context of describing structures, components, items, objects and/or things, the phrase “at least one of A or B” is intended to refer to implementations including any of (1) at least one A, (2) at least one B, or (3) at least one A and/or at least one B. As used herein in the context of describing the performance or execution of processes, instructions, actions, activities, etc., the phrase “at least one of A and/or B” is intended to refer to implementations including any of (1) at least one A, (2) at least one B, or (3) at least one A and/or at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and/or at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and/or “at least one” are used interchangeably herein. Furthermore, although individually listed, a plurality of means, elements, or actions may be implemented by, e.g., the same entity or object. Additionally, although individual features may be included in different examples or claims, these may possibly be combined, and/or the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and/or the first part. Likewise, as used herein, a first part is “below” a second part when the first part is closer to the Earth than the second part. As noted above, a first part can be above or below a second part with one or more of: other parts therebetween, without other parts therebetween, with the first and/or second parts touching, or without the first and/or second parts being in direct contact with one another.

As used herein, connection references (e.g., attached, coupled, connected, and/or joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” “third”, or “fourth.” In such instances, it should be understood that such descriptors are used merely for identifying those elements distinctly within the context of the discussion (e.g., within a claim) in which the elements might, for example, otherwise share a same name.

As used herein, “approximately” and/or “about” modify their subjects/values to recognize the potential presence of variations that occur in real world applications. For example, “approximately” and/or “about” may modify dimensions that may not be exact due to manufacturing tolerances and/or other real world imperfections as will be understood by persons of ordinary skill in the art. For example, “approximately” and/or “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and/or does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and/or including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and/or including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and/or orchestration technology (e.g., application programming interface(s) (API(s)) that may assign computing task(s) to whichever one(s) of the multiple types of programmable circuitry is/are suited and/or available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and/or methods have been disclosed that enable the assignment of a workload to an edge device based on GHG emissions that may result from the execution of the workload. Disclosed systems, apparatus, articles of manufacture, and/or methods improve the efficiency of using a computing device and/or reduce GHG emissions produced by such devices by estimating GHG emissions to be caused by: running a workload on the selected edge device, cooling the selected edge device while it runs the workload, and/or reducing the lifespan of the selected edge device as a result of running the proposed workload. Example emissions estimator circuitry 404 produces the emissions estimates by implementing one or more machine learning models that include factors such as performance metrics of the workload, renewable availability data, thermal budgets, ambient temperature, age of the device, component profiles, etc. An example GHG-aware scheduling system can assign the workload by considering: one or more of the foregoing emissions estimates, a GHG value that summarizes the three estimates, and/or other load balancing factors (e.g., computational efficiency, utilization of edge devices, etc.) Disclosed systems, apparatus, articles of manufacture, and/or methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and/or methods have been disclosed herein, the scope of coverage of this patent is not limited thereto. On the contrary, this patent covers all systems, apparatus, articles of manufacture, and/or methods fairly falling within the scope of the claims of this patent.

1. A non-transitory machine-readable storage medium comprising instructions to cause programmable circuitry to at least:
obtain a first response associated with an estimate of emissions to be produced by execution of a workload on first hardware;
obtain a second response associated with an estimate of emissions to be produced by execution of the workload on second hardware; and
assign one of the first or the second hardware to execute the workload based on the first response and the second response, the assigned one of the first or the second hardware to at least one of utilize more time or more memory to execute the workload than the other of the first or the second hardware.

2. The non-transitory machine-readable storage medium of claim 1, wherein the estimate of the first response is associated with one or more of:
first greenhouse gas (GHG) emissions produced to execute the workload on the first hardware;
second GHG emissions produced to cool the first hardware during execution of the workload;
third GHG emissions produced due to a change in lifespan of the first hardware caused by execution of the workload; or
fourth GHG emissions corresponding to a network transmission path.

3. The non-transitory machine-readable storage medium of claim 2, wherein the estimate of the first response is associated with a GHG value that represents the one or more of the first GHG emissions, the second GHG emissions, the third GHG emissions, or the fourth GHG emissions.

4. The non-transitory machine-readable storage medium of claim 3, wherein:
the GHG value is a first GHG value corresponding to the first response;
the second response includes a second GHG value; and
the programmable circuitry is to assign the workload to one of the first hardware or the second hardware based on a comparison between the first GHG value and/or the second GHG value.

5. The non-transitory machine-readable storage medium of claim 3, wherein the programmable circuitry is to:
the GHG value is a first GHG value corresponding to the first response;
assign the workload to the first hardware;
receive, after the assignment, a third response representing emissions that have been produced by execution of the workload on the first hardware, the third response including a second GHG value;
compare the first GHG value to the second GHG value; and
assign the workload to the second hardware for a further execution of the workload based on the comparison.

6. The non-transitory machine-readable storage medium of claim 5, wherein the second GHG value is different from the first GHG value due to one or more of:
a change in energy sources used to power the first hardware;
a change in energy sources used to cool the first hardware; and
a change in ambient temperature of the first hardware.

7. The non-transitory machine-readable storage medium of claim 1, wherein:
the first hardware includes a plurality of hardware circuits; and
the programmable circuitry is to assign the workload to ones of the plurality of hardware circuits based on the first response and the second response.

8. The non-transitory machine-readable storage medium of claim 7, wherein:
the plurality of hardware circuits are first hardware circuits including a first processor, the first processor having first characteristics that influence GHG emissions;
the second hardware includes a second processor having second characteristics that influence GHG emissions; and
the programmable circuitry is to assign one of the first hardware or the second hardware based on a difference between the first characteristics and the second characteristics, the first characteristics represented in the first response, the second characteristics represented in the second response.

9. The non-transitory machine-readable storage medium of claim 1, wherein:
the programmable circuitry is to obtain the first hardware emissions estimate within a telemetry stream; and
the first response indicates the telemetry stream has been initiated.

10. The non-transitory machine-readable storage medium of claim 1, wherein one or more of the first response and the second response are application programming interface (API) responses.

11. An apparatus to assign a workload, the apparatus comprising:
interface circuitry to:
obtain a first response associated with an estimate of emissions to be produced by execution of a workload on first hardware;
obtain a second response associated with an estimate of emissions to be produced by execution of the workload on second hardware;
instructions; and
programmable circuitry to at least one of instantiate or execute the instructions to assign one of the first or the second hardware to execute the workload based on the first response and the second response, the assigned one of the first or the second hardware to at least one of utilize more time or more memory to execute the workload than the other of the first or the second hardware.

12. The apparatus of claim 11, wherein the estimate of the first response is associated with one or more of:
first greenhouse gas (GHG) emissions produced to execute the workload on the first hardware;
second GHG emissions produced to cool the first hardware during execution of the workload;
third GHG emissions produced due to a change in lifespan of the first hardware caused by execution of the workload; or
fourth GHG emissions corresponding to a network transmission path.

13. The apparatus of claim 12, wherein the estimate of the first response is associated with a GHG value that represents the one or more of the first GHG emissions, the second GHG emissions, the third GHG emissions, or the fourth GHG emissions.

14. The apparatus of claim 13, wherein:
the GHG value is a first GHG value corresponding to the first response;
the second response includes a second GHG value; and
the programmable circuitry is to assign the workload to one of the first hardware or the second hardware based on a comparison between the first GHG value and the second GHG value.

15. The apparatus of claim 13, wherein the programmable circuitry is to:
assign the workload to the first hardware;
receive, after the assignment, a third response representing emissions that have been produced by execution of the workload on the first hardware, the third response including a second GHG value;
compare the first GHG value to the second GHG value; and
assign the workload to the second hardware for a further execution of the workload based on the comparison.

16. The apparatus of claim 15, wherein the second GHG value is different from the first GHG value due to one or more of:
a change in energy sources used to power the first hardware;
a change in energy sources used to cool the first hardware; and
a change in ambient temperature of the first hardware.

17. The apparatus of claim 11, wherein:
the first hardware includes a plurality of hardware circuits; and
the programmable circuitry is to assign the workload to ones of the plurality of hardware circuits based on the first response and the second response.

18. The apparatus of claim 17, wherein:
the plurality of hardware circuits are first hardware circuits including a first processor, the first processor having first characteristics that influence GHG emissions;
the second hardware includes a second processor having second characteristics that influence GHG emissions; and
the programmable circuitry is to assign one of the first hardware or the second hardware based on a difference between the first characteristics and the second characteristics, the first characteristics represented in the response, the second characteristics represented in the second response.

19. The apparatus of claim 11, wherein:
the programmable circuitry is to obtain the first hardware emissions estimate within a telemetry stream; and
the first response indicates the telemetry stream has been initiated.

20. The apparatus of claim 11, wherein one or more of the first response and the second response are application programming interface (API) responses.

21-29. (canceled)
